(19) United States
(12) Patent Application Publication
(10) Pub. No.: US 2025/0084927 A1
(43) Pub. Date: Mar. 13, 2025

(54) PRESSURE RELIEF ASSEMBLY

(71) Applicant: Donaldson Company, Inc., Bloomington, MN (US)

(72) Inventors: Matthew P. Brownson, Stillwater, MN (US); Isaac J. Laffey, Waterloo, IA (US); Matthew J. Goode, Blaine, MN (US); Aflal Rahmathullah, Savage, MN (US); Suresh B. Bommineni, Shakopee (IN); Daniel P. Little, Eden Prairie, MN (US); Marc J. Andvik, Bloomington, MN (US); Robert O. Nelson, Eagan, MN (US); Michael S. Libbey, Edina, MN (US); Dustin M. Meier, Edina, MN (US)

(21) Appl. No.: 18/827,416

(22) Filed: Sep. 6, 2024

Related U.S. Application Data
(60) Provisional application No. 63/537,415, filed on Sep. 8, 2023.
(60) Provisional application No. 63/537,419, filed on Sep. 8, 2023.

(51) Int. Cl. F16K 17/02; F16K 17/16; F16K 25/00; F16K 31/00; F16K 31/08

(52) U.S. Cl. CPC F16K 17/02; F16K 25/005; F16K 31/003; F16K 31/084; F16K 17/162

(57) ABSTRACT

The pressure relief assembly has a valve body constructed of breathable porous plastic. The valve body has an outer perimetric surface defining a detent mating surface and a sealing surface configured to form a seal around a valve opening. A first detent has a detent engagement surface configured to releasably engage the detent mating surface. The first detent is configured to release the valve body upon a minimum pressure differential across the valve body. The first detent is configured to extent laterally outward from the detent mating surface. The pressure relief assembly has a frame having a coupling structure configured to couple to an enclosure. The pressure relief assembly has a valve mounting surface and a valve opening within the valve mounting surface, where the valve body is sealably disposed on the valve mounting surface across the valve opening.

### RELATED APPLICATIONS

This application claims the benefit of U.S. Provisional Application Nos. 63/537,415, and 63/537,419, each filed 8 Sep. 2023, the disclosures of which are incorporated by reference herein in their entireties.

### TECHNOLOGICAL FIELD

The present disclosure is generally related to an assembly. More Particularly, the present disclosure is related to a pressure relief assembly.

### SUMMARY

Some embodiments of the technology disclosed herein relate to a pressure relief assembly. The pressure relief assembly has a valve body constructed of breathable porous plastic. The valve body has an outer perimetric surface defining a detent mating surface and a sealing surface configured to form a seal around a valve opening. A first detent has a detent engagement surface configured to releasably engage the detent mating surface. The first detent is configured to release the valve body upon a minimum pressure differential across the valve body. The first detent is configured to extent laterally outward from the detent mating surface.

In some such embodiments, the pressure relief assembly has a frame having a coupling structure configured to couple to an enclosure. The pressure relief assembly has a valve mounting surface and a valve opening within the valve mounting surface, where the valve body is sealably disposed on the valve mounting surface across the valve opening. Additionally or alternatively the first detent is coupled to the frame. Additionally or alternatively the frame further is constructed of a breathable porous plastic. Additionally or alternatively the valve body has an oleophobic coating. Additionally or alternatively the valve body has a mean pore size of 0.1 μm to 100 μm, 0.1 μm to 10 μm, or 1 μm to 50 μm. Additionally or alternatively the valve body has a maximum pore size of less than 350 μm, 200 μm, 100 μm, or 50 μm. Additionally or alternatively the valve body has a void volume between 30% to 50%.

Additionally or alternatively, the valve body is constructed of at least one polymer in the group consisting of: polytetrafluoroethylene, polysulfone, polyethylene, polyethylenimine, polypropylene and polyvinylidene difluoride. Additionally or alternatively, the valve body includes ceramic. Additionally or alternatively, the valve body includes an adsorbent. Additionally or alternatively the valve body defines a cavity and the adsorbent is disposed in the cavity. Additionally or alternatively, the valve body is constructed of adsorbent particles. Additionally or alternatively, the adsorbent particles include carbon particles. Additionally or alternatively, the valve body is configured to obstruct passage of liquid water. Additionally or alternatively, the valve body further defines a hinge that is configured to pivotably couple the valve body to an enclosure. Additionally or alternatively, the valve body has a plug portion and a valve stem extending in an axial direction from the plug portion, where the first detent extends laterally to the valve stem.

Additionally or alternatively, the first detent is a spring-loaded detent. Additionally or alternatively, the first detent has a detent housing having a first end and an open second end, a compression spring disposed in the detent housing, the compression spring extending from the first end towards the open second end, wherein the detent engagement surface is translatably disposed in the detent housing, and wherein the compression spring is compressibly disposed between the detent engagement surface and the first end of the detent housing. Additionally or alternatively, the first detent is a magnet. Additionally or alternatively, the valve has a valve sidewall around the valve opening and the frame comprises a frame sidewall around the valve opening, wherein the frame sidewall is spaced radially outward from the valve sidewall.

Some embodiments of the technology disclosed herein relates to a pressure relief assembly having a valve body constructed of a breathable porous plastic having sealing surface configured to form a seal around a valve opening. The valve body has an unweakened region having a first thickness and a weakened region having a second thickness that is less than the first thickness, where the valve body has a threshold rupture pressure defined by the weakened region.

In some such embodiments, the assembly has a frame including a coupling structure configured to couple to an enclosure, a valve mounting surface, and
a valve opening within the valve mounting surface, where the valve body is sealably disposed on the valve mounting surface across the valve opening. Additionally or alternatively, the frame is constructed of a breathable porous plastic. Additionally or alternatively, the valve body further includes a coupling structure configured to couple to an enclosure. Additionally or alternatively, the coupling structure includes a threaded circumferential surface. Additionally or alternatively, the coupling structure includes a snap fit. Additionally or alternatively, the coupling structure includes a bayonet connector. Additionally or alternatively, an enclosure is configured to be overmolded to the valve body. Additionally or alternatively, the valve body has an oleophobic coating. Additionally or alternatively, the valve body is configured to obstruct passage of liquid water.

Additionally or alternatively, the valve body has a mean pore size of 0.1 μm to 100 μm, 0.1 μm to 10 μm, or 1 μm to 50 μm. Additionally or alternatively, the valve body has a maximum pore size of less than 350 μm, 200 μm, 100 μm, or 50 μm. Additionally or alternatively, the valve body has a void volume between 30% to 50%. Additionally or alternatively, the valve body includes at least one polymer in the group consisting of: polytetrafluoroethylene, polysulfone, polyethylene, polyethylenimine, polypropylene and polyvinylidene difluoride. Additionally or alternatively, the valve body includes ceramic. Additionally or alternatively, the valve body includes an adsorbent. Additionally or alternatively, the valve body defines a cavity and the adsorbent is disposed in the cavity. Additionally or alternatively, the valve body is constructed of adsorbent particles. Additionally or alternatively, the adsorbent particles comprise carbon particles.

Some embodiments of the technology disclosed herein relates to a pressure relief assembly having a housing, a passive airflow vent, and a one-way relief valve. The housing defines a cavity, a first end, a second end, a vent opening, a valve opening, and a coupling structure configured to couple to an enclosure. The passive airflow vent is disposed in the housing across the vent opening. The passive airflow vent is a porous plastic plug. The housing defines a housing opening between an ambient environment and the passive airflow vent. The one-way relief valve is disposed in the housing and forms a seal over the valve opening. The one-way relief valve is arranged in parallel with the passive airflow vent with respect to airflow through the housing.

Additionally or alternatively, the valve opening comprises a plurality of openings defining a segmented annulus about the central axis. Additionally or alternatively, the fluid flow pathway defines a tortuous path between the housing opening and the one-way relief valve. Additionally or alternatively, the pressure relief assembly further comprising an cap coupled to the housing towards the first end. Additionally or alternatively, the cap defines the first end of the housing and the cap extends across the one-way relief valve and the passive airflow vent.

Additionally or alternatively, the housing comprising a first obstruction, wherein the first obstruction is positioned between the housing opening and the passive airflow vent. Additionally or alternatively, the housing comprising a second obstruction extending into the fluid flow pathway, wherein the second obstruction is positioned between the housing opening and the one-way relief valve. Additionally or alternatively, the coupling structure defining a fluid flow pathway between an outside of the housing and the passive airflow vent. Additionally or alternatively, the housing defines a first fluid flow pathway between an outside of the housing and the passive airflow vent, the coupling structure defines a second fluid flow pathway between the outside of the housing and the passive airflow vent, and the one-way relief valve is configured to unseal when the pressure in the second fluid flow pathway is greater than the pressure in the first fluid flow pathway by 0.5 to 1 psi.

Additionally or alternatively, the housing further defines a mounting surface that defines the vent opening. Additionally or alternatively, the vent opening is a plurality of openings defining a segmented annulus about the central axis. Additionally or alternatively, the one-way relief valve is an umbrella valve. Additionally or alternatively, the housing defines radial openings about the central axis, wherein the radial openings define a fluid flow pathway between an outside of the housing and the passive airflow vent. Additionally or alternatively, the passive airflow vent and the one-way relief valve are concentric. Additionally or alternatively, the pressure relief assembly further comprising a seal abutting the coupling structure.

Some embodiments of the technology disclosed herein relate to a vent assembly. The vent assembly has a vent housing having a first end and a second end. The vent housing defines a mounting structure and an airflow pathway extending from the mounting structure to the environment external to the vent housing. A porous plug is coupled to the vent housing and disposed across the airflow pathway.

In some such embodiments, the porous plug can be positioned between the first end and the second end. Additionally or alternatively, the vent assembly is not a hub cap vent. Additionally or alternatively, the porous plug has a mean pore size of 0.1 μm to 100 μm, 0.1 μm to 10 μm, or 1 μm to 50 μm. Additionally or alternatively, the porous plug has a maximum pore size of less than 350 μm, 200 μm, 100 μm, or 50 μm. Additionally or alternatively, the porous plug has a void volume between 30% to 50%. Additionally or alternatively, the porous plug has a pore size range that changes from a first axial end of the porous plug to a second axial end of the porous plug.

Additionally or alternatively, the porous plug comprises at least one polymer in the group consisting of: polytetrafluoroethylene, polysulfone, polyethylene, polyethylenimine, polypropylene and polyvinylidene difluoride. Additionally or alternatively, the porous plug comprises ceramic. Additionally or alternatively, the porous plug comprises sintered metal. Additionally or alternatively, the porous plug comprises an adsorbent. Additionally or alternatively, the porous plug comprises adsorbent particles. Additionally or alternatively, the adsorbent particles comprise carbon particles. Additionally or alternatively, the porous plug has a thickness in the range of 0.02-4.0 inches or 0.03-2.0 inches. Additionally or alternatively, the porous plug defines a check valve positioned towards the first end of the vent housing to selectively obstruct the airflow pathway. Additionally or alternatively, the porous plug has an oleophobic coating.

Additionally or alternatively, the porous plug and the vent housing define mating threads. Additionally or alternatively, the porous plug defines a taper in an axial direction. Additionally or alternatively, the airflow pathway defines a taper in the axial direction. Additionally or alternatively, the porous plug and the vent housing define a frictional fit. Additionally or alternatively, the porous plug and the vent housing are welded. Additionally or alternatively, the vent assembly further comprising coalescing filter media disposed within the vent housing such that the airflow pathway and the environment external to the vent housing are in communication through the coalescing filter media. Additionally or alternatively, the porous plug is a first porous plug, and wherein the vent assembly comprises a second porous plug disposed across the airflow pathway, the second porous plug having a different porosity than the first porous plug, and the first porous plug and the second porous plug arranged in series along the airflow pathway.

Additionally or alternatively, the porous plug defines a plurality of laterally extending layers arranged in an axial direction and at least one cavity between the layers. Additionally or alternatively, the porous plug defines a plurality of cavities. Additionally or alternatively, the porous plug defines a draining pathway through the first end. Additionally or alternatively, at least one of the laterally extending layers define an incline in the axial direction. Additionally or alternatively, the vent assembly further comprising a passive airflow vent disposed in the vent housing across the airflow pathway. Additionally or alternatively, the passive airflow vent is the porous plug. Additionally or alternatively, the passive airflow vent is a breathable membrane.

Additionally or alternatively, the vent assembly defines a coalescing region within the airflow pathway between the mounting structure and the passive airflow vent. Additionally or alternatively, the coalescing region comprises coalescing filter media. Additionally or alternatively, the coalescing region comprises the porous plug. Additionally or alternatively, the porous plug is positioned towards the first end relative to the coalescing filter media. Additionally or alternatively, the vent assembly defines a spacing region between the coalescing region and the passive airflow vent. Additionally or alternatively, the vent assembly further comprising a media spacer between the coalescing filter media and the porous plug, wherein the media spacer is configured to prevent contact between the coalescing region and the porous plug and is configured to define a portion of the airflow pathway.

Additionally or alternatively, the housing defines perimeter openings such that the airflow pathway extends from the porous plug to the external environment through the perimeter openings. Additionally or alternatively, the vent housing is constructed of porous plastic. Additionally or alternatively, the housing comprises a cap towards the second end, wherein the cap extends across the airflow pathway. Additionally or alternatively, the cap is porous.

Some embodiments of the technology disclosed herein relate to a vent assembly. The vent assembly has a vent housing having a first end and a second end. The vent housing defines a mounting structure and an airflow pathway extending from the mounting structure to the environment external to the vent housing. A porous plug is coupled to the vent housing and disposed across the airflow pathway. The porous plug defines a plurality of laterally extending layers arranged in an axial direction and at least one cavity between the layers.

In some such embodiments, the porous plug has a mean pore size of 0.1 μm to 100 μm, 0.1 μm to 10 μm, or 1 μm to 50 μm. Additionally or alternatively, the porous plug has a maximum pore size of less than 350 μm, 200 μm, 100 μm, or 50 μm. Additionally or alternatively, the porous plug has a void volume between 30% to 50%. Additionally or alternatively, the porous plug has a pore size range that changes from a first axial end of the porous plug to a second axial end of the porous plug. Additionally or alternatively, the porous plug comprises at least one polymer in the group consisting of: polytetrafluoroethylene, polysulfone, polyethylene, polyethylenimine, polypropylene and polyvinylidene difluoride.

Additionally or alternatively, the porous plug comprises ceramic. Additionally or alternatively, the porous plug comprises sintered metal. Additionally or alternatively, the porous plug comprises an adsorbent. Additionally or alternatively, the porous plug comprises adsorbent particles. Additionally or alternatively, the adsorbent particles comprise carbon particles. Additionally or alternatively, the porous plug has a thickness in the range of 0.02-4.0 inches or 0.03-2.0 inches. Additionally or alternatively, the porous plug defines a check valve positioned towards the first end of the vent housing to selectively obstruct the airflow pathway. Additionally or alternatively, the porous plug has an oleophobic coating. Additionally or alternatively, the porous plug and the vent housing define mating threads. Additionally or alternatively, the porous plug defines a taper in an axial direction. Additionally or alternatively, the airflow pathway defines a taper in the axial direction. Additionally or alternatively, the porous plug and the vent housing define a frictional fit. Additionally or alternatively, the porous plug and the vent housing are welded. Additionally or alternatively, the vent assembly further comprising coalescing filter media disposed within the vent housing such that the airflow pathway and the environment external to the vent housing are in communication through the coalescing filter media. Additionally or alternatively, the porous plug is a first porous plug, and wherein the vent assembly comprises a second porous plug disposed across the airflow pathway, the second porous plug having a different porosity than the first porous plug, and the first porous plug and the second porous plug arranged in series along the airflow pathway.

Additionally or alternatively, the porous plug defines a plurality of cavities. Additionally or alternatively, the porous plug defines a draining pathway through the first end. Additionally or alternatively, at least one of the laterally extending layers define an incline in the axial direction. Additionally or alternatively, the vent assembly further comprising a passive airflow vent disposed in the vent housing across the airflow pathway. Additionally or alternatively, the passive airflow vent is a breathable membrane.

Additionally or alternatively, the vent assembly defines a coalescing region within the airflow pathway between the mounting structure and the passive airflow vent. Additionally or alternatively, the coalescing region comprises coalescing filter media. Additionally or alternatively, the coalescing region comprises the porous plug. Additionally or alternatively, the porous plug is positioned towards the first end relative to the coalescing filter media. Additionally or alternatively, the vent assembly defines a spacing region between the coalescing region and the passive airflow vent. Additionally or alternatively, the passive airflow vent further comprising a media spacer between the coalescing filter media and the porous plug, wherein the media spacer is configured to prevent contact between the coalescing region and the porous plug and is configured to define a portion of the airflow pathway.

Additionally or alternatively, the housing defines perimeter openings such that the airflow pathway extends from the porous plug to the external environment through the perimeter openings. Additionally or alternatively, the vent housing is constructed of porous plastic. Additionally or alternatively, the housing comprises a cap towards the second end, wherein the cap extends across the airflow pathway. Additionally or alternatively, the cap is constructed of porous plastic. Additionally or alternatively, the porous plug defines a cavity and adsorbent is disposed in the cavity.

Some embodiments of the technology disclosed herein relate to a vent assembly. The vent assembly has a vent housing having a first end and a second end. The vent housing has a mounting structure, a vent body defining the second end, and a second airflow pathway. The mounting structure is configured to couple to an enclosure. The mounting structure defines a first airflow pathway configured for fluid communication with an interior of the enclosure. The vent body is coupled to the mounting structure and the vent body is constructed of a porous plastic defining pores. The second airflow pathway is configured for fluid communication with the environment external to the vent housing. The second airflow pathway extends through the pores.

Additionally or alternatively, the vent body and the mounting structure are an integral, unitary component. Additionally or alternatively, the mounting structure is constructed of porous plastic. Additionally or alternatively, the vent body and the mounting structure form a structural fastener. Additionally or alternatively, the vent body and the mounting structure define a reservoir cover. Additionally or alternatively, the vent body and the mounting structure define a hose. Additionally or alternatively, the vent body extends axially outward from the mounting structure. Additionally or alternatively, the vent body defines an elongate cavity. Additionally or alternatively, the vent assembly does not define openings in addition to the pores towards the second end. Additionally or alternatively, the vent body comprises a cap towards the second end.

Additionally or alternatively, the vent body has a mean pore size of 0.1 μm to 100 μm, 0.1 μm to 10 μm, or 1 μm to 50 μm. Additionally or alternatively, the vent body has a maximum pore size of less than 350 μm, 200 μm, 100 μm, or 50 μm. Additionally or alternatively, the vent body has a void volume between 30% to 50%. Additionally or alternatively, the vent body has a pore size range that changes from a first axial end of the vent body to a second axial end of the vent body. Additionally or alternatively, the vent body comprises at least one polymer in the group consisting of: polytetrafluoroethylene, polysulfone, polyethylene, polyethylenimine, polypropylene and polyvinylidene difluoride.

Additionally or alternatively, the vent body comprises ceramic. Additionally or alternatively, the vent body comprises sintered metal. Additionally or alternatively, the vent body comprises an adsorbent. Additionally or alternatively, the vent body comprises adsorbent particles. Additionally or alternatively, the adsorbent particles comprise carbon particles.

Additionally or alternatively, the vent assembly further comprising coalescing filter media disposed within the vent housing such that the first airflow pathway and the second airflow pathway are in communication through the coalescing filter media. Additionally or alternatively, the vent assembly further comprising a porous plug disposed in the vent housing such that the first airflow pathway and the second airflow pathway are in communication through the porous plug. Additionally or alternatively, the porous plug and the vent housing define mating threads. Additionally or alternatively, the porous plug defines a taper in an axial direction. Additionally or alternatively, the airflow pathway defines a taper in the axial direction. Additionally or alternatively, the porous plug and the vent housing define a frictional fit.

Additionally or alternatively, the porous plug is a first porous plug, and wherein the vent assembly comprises a second porous plug disposed in the housing, the second porous plug having a different porosity than the first porous plug, and the first porous plug and the second porous plug arranged in series between the first airflow pathway and the second airflow pathway. Additionally or alternatively, the porous plug has an oleophobic coating. Additionally or alternatively, the porous plug defines a plurality of laterally extending layers arranged in an axial direction and at least one cavity between the layers. Additionally or alternatively, the porous plug defines a plurality of cavities.

Additionally or alternatively, the porous plug defines a draining pathway through the first end. Additionally or alternatively, the porous plug and the vent housing are welded. Additionally or alternatively, the porous plug has a mean pore size of 0.1 μm to 100 μm, 0.1 μm to 10 μm, or 1 μm to 50 μm. Additionally or alternatively, the porous plug has a maximum pore size of less than 350 μm, 200 μm, 100 μm, or 50 μm. Additionally or alternatively, the porous plug has a void volume between 30% to 50%. Additionally or alternatively, the porous plug defines a cavity and adsorbent is disposed in the cavity. Additionally or alternatively, the porous plug has a pore size range that changes from a first axial end of the porous plug to a second axial end of the porous plug.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a perspective exploded view of an example pressure relief assembly consistent with the technology disclosed herein.

FIG. 2 is a perspective view of another example pressure relief assembly.

FIG. 3 is an exploded view from a second perspective of the example pressure relief assembly of FIG. 2.

FIG. 4 is a cross-sectional view of the example pressure relief assembly of FIG. 2.

FIG. 5 is an exploded view of yet another example pressure relief assembly consistent with the technology disclosed herein.

FIG. 6 is a cross-sectional view of the example pressure relief assembly of FIG. 5.

FIG. 7 is a cross-sectional view of yet another pressure relief assembly consistent with the technology disclosed herein.

FIG. 8 is an exploded view of yet another example pressure relief assembly consistent with the technology disclosed herein.

FIG. 9 is a cross-sectional view of yet another example pressure relief assembly consistent the technology disclosed herein.

FIG. 10 is a cross-sectional exploded perspective view of the pressure relief assembly of FIG. 9.

FIG. 11 is a cross-sectional view of another pressure relief assembly consistent with the technology disclosed herein.

FIG. 12 is a cross-sectional exploded perspective view of the pressure relief assembly of FIG. 11.

FIG. 13 is an exploded perspective cross-sectional view of another example pressure relief assembly.

FIG. 14 is a cross-sectional view of another example pressure relief assembly.

FIG. 15 depicts facing view of an example pressure relief assembly having a rupture disk consistent with various embodiments.

FIG. 16 is a cross-sectional view of the example rupture disk of FIG. 15.

FIG. 17 is a perspective view of another example pressure relief assembly having a rupture disk consistent with some embodiments.

FIG. 18 depicts a perspective view of another pressure relief assembly having a rupture disk consistent with various embodiments.

FIG. 19 depicts a perspective view of another pressure relief assembly having a rupture disk consistent with various embodiments.

FIG. 20 depicts a cross-sectional view of the example pressure relief assembly having a rupture disk.

FIG. 21 is a cross-sectional view of yet another example pressure relief assembly consistent with the technology disclosed herein.

FIG. 22 is a perspective cross-sectional view of yet another example pressure relief assembly consistent with the technology disclosed herein.

FIG. 23 is a cross sectional view of a vent assembly consistent with the technology disclosed herein.

FIG. 24 is a perspective view of a vent assembly consistent with the technology disclosed herein.

FIG. 25A is a cross sectional view of a vent assembly consistent with the technology disclosed herein.

FIG. 25B is a cross sectional view of a vent assembly consistent with the technology disclosed herein.

FIG. 26 is a cross sectional view of a vent assembly consistent with the technology disclosed herein.

FIG. 27 is a cross sectional view of a vent assembly consistent with the technology disclosed herein.

FIG. 28 is a cross sectional view of a vent assembly consistent with the technology disclosed herein.

FIG. 29A is a cross sectional view of a vent assembly consistent with the technology disclosed herein.

FIG. 29B is a cross sectional view of a vent assembly consistent with the technology disclosed herein.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

Pressure relief assemblies consistent with the technology disclosed herein are generally configured to provide pressure relief to an enclosure when the pressure within the enclosure exceeds a minimum pressure differential relative to an environment outside of the enclosure. The pressure relief assembly is generally configured to be coupled to the enclosure, where the enclosure is generally not a component of the pressure relief assembly. The pressure relief assembly can be configured to facilitate selective pressure equalization of the enclosure while preventing the entry of contaminants, such as particles and liquids (such as water), into the enclosure. The enclosure is generally configured to house system components such as electronic components and battery cells, as examples. In some examples, the enclosure is a battery housing.

Some embodiments of the technology disclosed herein incorporates one or more detents that may advantageously allow re-use of the pressure relief assembly after release of the pressure relief valve. In particular, detents that can be used to release the pressure relief valve may be configured to be deployed multiple times without mechanical/physical degradation, which allows for a predictable minimum pressure differential to trigger deployment of the valve. The reusability of the pressure relief assembly may advantageously allow performance testing of every component prior to use by an end customer, for example. The reusability of the pressure relief assembly may advantageously allow re-use by an end customer, as another example.

### Exemplary Aspects of a Pressure Relief Assembly With a Detent

Aspect 1. A pressure relief assembly comprising:
a valve body comprising breathable porous plastic having: an outer perimetric surface defining a detent mating surface, and a sealing surface configured to form a seal around a valve opening; and
a first detent having a detent engagement surface configured to releasably engage the detent mating surface, wherein the first detent is configured to release the valve body upon a minimum pressure differential across the valve body and the first detent is configured to extent laterally outward from the detent mating surface.

Aspect 2. The pressure relief assembly of any one of Aspects 1 and 3-20, further comprising a frame comprising a coupling structure configured to couple to an enclosure, a valve mounting surface, and a valve opening within the valve mounting surface, wherein the valve body is sealably disposed on the valve mounting surface across the valve opening.

Aspect 3. The pressure relief assembly of any one of Aspects 1-2 and 4-20, wherein the first detent is coupled to the frame.

Aspect 4. The pressure relief assembly of any one of Aspects 1-3 and 5-20, wherein the frame further comprises breathable porous plastic.

Aspect 5. The pressure relief assembly of any one of Aspects 1-4 and 6-20, wherein the valve body has an oleophobic coating.

Aspect 6. The pressure relief assembly of any one of Aspects 1-5 and 7-20, wherein the valve body has a mean pore size of 0.1 μm to 100 μm, 0.1 μm to 10 μm, or 1 μm to 50 μm.

Aspect 7. The pressure relief assembly of any one of Aspects 1-6 and 8-20, wherein the valve body has a maximum pore size of less than 350 μm, 200 μm, 100 μm, or 50 μm.

Aspect 8. The pressure relief assembly of any one of Aspects 1-7 and 9-20, wherein the valve body has a void volume between 30% to 50%.

Aspect 9. The pressure relief assembly of any one of Aspects 1-8 and 10-20, wherein the valve body comprises at least one polymer in the group consisting of: polytetrafluoroethylene, polysulfone, polyethylene, polyethylenimine, polypropylene and polyvinylidene difluoride.

Aspect 10. The pressure relief assembly of any one of Aspects 1-9 and 11-20, wherein the valve body comprises ceramic.

Aspect 11. The pressure relief assembly of any one of Aspects 1-10 and 12-20, wherein the valve body comprises an adsorbent.

Aspect 12. The pressure relief assembly of any one of Aspects 1-11 and 13-20, wherein the valve body defines a cavity and the adsorbent is disposed in the cavity.

Aspect 13. The pressure relief assembly of any one of Aspects 1-12 and 14-20, wherein the valve body comprises adsorbent particles.

Aspect 14. The pressure relief assembly of any one of Aspects 1-13 and 15-20, wherein the adsorbent particles comprise carbon particles.

Aspect 15. The pressure relief assembly of any one of Aspects 1-14 and 16-20, wherein the valve body is configured to obstruct passage of liquid water.

Aspect 16. The pressure relief assembly of any one of Aspects 1-15 and 17-20, where the valve body further comprises a hinge that is configured to pivotably couple the valve body to an enclosure.

Aspect 17. The pressure relief assembly of any one of Aspects 1-16 and 18-20, the valve body comprising a plug portion and a valve stem extending in an axial direction from the plug portion, wherein the first detent extends laterally to the valve stem.

Aspect 18. The pressure relief assembly of any one of Aspects 1-17 and 19-20, wherein the first detent is a spring-loaded detent.

Aspect 19. The pressure relief assembly of any one of Aspects 1-18 and 20, wherein the first detent comprises a detent housing having a first end and an open second end, a compression spring disposed in the detent housing, the compression spring extending from the first end towards the open second end, wherein the detent engagement surface is translatably disposed in the detent housing, and wherein the compression spring is compressibly disposed between the detent engagement surface and the first end of the detent housing.

Aspect 20. The pressure relief assembly of any one of Aspects 1-19, wherein the first detent is a magnet.

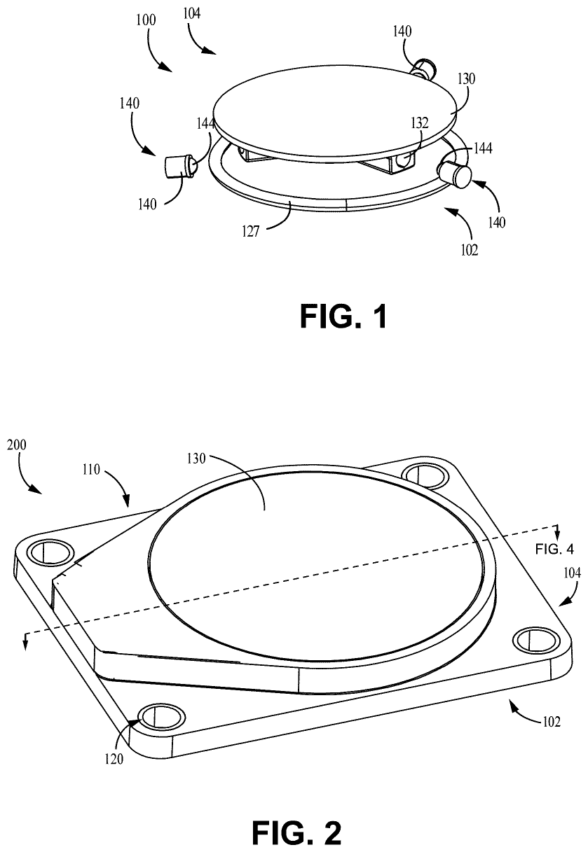

FIG. 1 is an exploded perspective view of an example pressure relief assembly consistent with the technology disclosed herein. The pressure relief assembly 100 is generally configured to be coupled to an enclosure about an opening in the enclosure that defines a valve airflow pathway. In some embodiments the pressure relief assembly 100 is configured to be releasably coupled to a valve frame that is configured to be fixed to an enclosure. In some other embodiments the pressure relief assembly 100 is configured to be releasably coupled directly to an enclosure.

The pressure relief assembly 100 generally has a valve body 130 and a first detent 140. The valve body 130 is generally configured to extend across a valve opening to selectively obstruct the valve opening. The valve body 130 generally has an outer perimetric surface defining a detent mating surface 132 and a sealing surface 127. The sealing surface 127 is configured to form a seal around a valve opening. The first detent 140 has a detent engagement surface 144, where the detent engagement surface 144 is configured to releasably engage the detent mating surface 132. The first detent 140 is configured to release the valve body 130 upon a minimum pressure differential across the valve body 130. The first detent 140 is additionally configured to extend laterally outward from the detent mating surface 132 when the detent mating surface 132 engages the detent engagement surface 144.

The valve body 130 is generally constructed of a breathable porous plastic material. In various embodiments, the valve body 130 itself is porous and breathable to facilitate passive airflow during normal operation conditions. The valve body 130 can be configured to prevent the ingress of outside contaminants through the valve opening. The valve body 130 is generally positioned in fluid communication with the enclosure. The valve body 130 is configured to allow gases to pass between the enclosure and the environment outside of the enclosure by flowing through valve body 130. In some embodiments, the valve body 130 is configured to prevent particles from entering into the enclosure. In some embodiments, the valve body 130 is also configured to prevent liquids from entering into the enclosure.

In some embodiments, the valve body 130 is generally configured to obstruct passage of liquid water. In such embodiments, the pores defined by the valve body 130 are sufficiently small to obstruct the passage of liquid water. In some embodiments, the pores defined by the valve body 130 accommodate passage of water vapor, however. Various types of materials would be suitable for use as the valve body. The valve body can have a mean pore size of 0.1 μm to 100 μm, 0.1 μm to 10 μm, or 1 μm to 50 μm. In some embodiments, the valve body has a maximum pore size of less than 350 μm, 200 μm, 100 μm, or 50 μm. The valve body 130 can have a void volume between 30% to 50% in various embodiments.

Generally, the valve body is a polymer such as: polytetrafluoroethylene, polysulfone, polyethylene, polyethylenimine, polypropylene and polyvinylidene difluoride, or the like. In some embodiments the valve body 130 can include ceramic. In some embodiments the valve body 130 can include sintered metal. In some embodiments, the valve body 130 has an adsorbent such as adsorbent particles. The adsorbent particles can be any suitable material, such as carbon particles or the like. In some embodiments the valve body 130 is partially constructed of carbon particles, and in some other embodiments the valve body 130 defines a cavity and carbon particles are disposed within the cavity.

In various embodiments, the valve body 130 has an oleophobic coating. Various types of methods would be suitable for use as the oleophobic coating. Modification of the surface characteristics of the valve body 130, such as to increase the contact angle between the surface of the valve body 130 and the oil, such as with an oleophobic treatment, can enhance drainage capability of the valve body 130 and facilitate release of oil by the surface of the valve body 130. Oleophobicity can be imparted to the valve body by depositing a layer of oleophobic fluorochemical on the surface and/or by submerging the valve body in a solution of the fluorochemical (dip coating), among other means. Lick rolling, gravure coating, and/or curtain coating are some other example ways that the valve body can be treated for oleophobicity.

In the current example, the pressure relief assembly 100 at least has a first detent 140. In this particular embodiment, the pressure relief assembly 100 has a plurality of detents. A detent is defined herein as a mechanical or magnetic structure that secures a first part to a second part and releases the first part from the second part upon a particular release force being applied to the first part. In accordance with the technology disclosed herein, the “first part” is generally the valve body 130, and the release force that is generally applied to the valve body is the pressure differential between the enclosure and the environment outside of the enclosure. In some embodiments, each detent is fixed to a valve assembly frame (not currently depicted), and in other embodiments the each detent is fixed to an enclosure (not currently depicted). In such embodiments each detent 140 frictionally engages the valve body, although the reverse configuration is also possible where each detent 140 is fixed to the valve body 130 and frictionally engages the valve assembly frame or enclosure about the valve opening. Furthermore, other types of detents are possible such as magnetic detents.

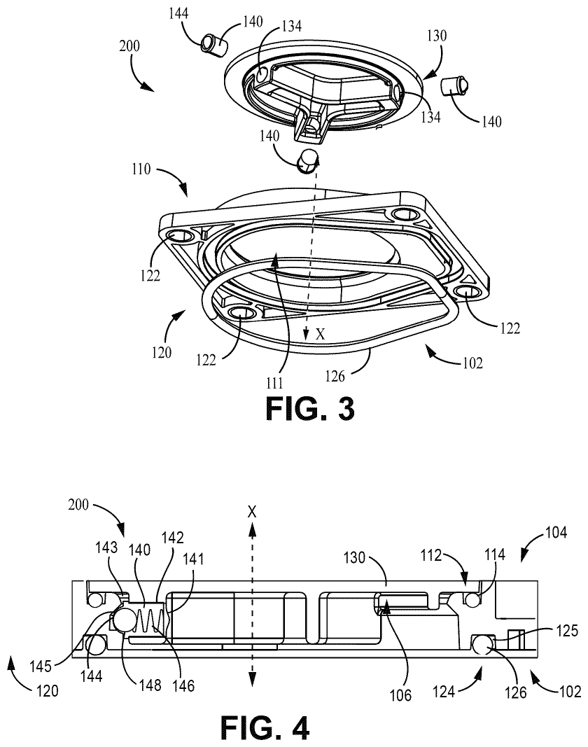

FIG. 2 is a perspective view of another example pressure relief assembly 200 incorporating a valve body 130 similar to that depicted in FIG. 1. FIG. 3 is an exploded view of the pressure relief assembly 200 and FIG. 4 is a cross-sectional view denoted in FIG. 2. In the current example, the pressure relief assembly 200 has a valve body 130 coupled to a frame 110. The pressure relief assembly 200 generally has a first axial end 102, a second axial end 104. The valve airflow pathway 106 is configured to be selectively obstructed by a valve body 130, where the valve body 130 is configured to relieve pressure when the pressure within the enclosure exceeds a minimum pressure differential relative to the environment outside of the enclosure.

The frame 110 is generally configured to support one or more components of the pressure relief assembly 100. The frame 110 has a coupling structure 120, a valve mounting surface 112, and a valve opening 111 within the valve mounting surface 112. The valve airflow pathway 106 selectively extends across the valve opening 111.

The coupling structure 120 is generally configured to sealably couple to an enclosure about an enclosure opening, which is not currently depicted. The coupling structure 120 is generally configured to engage the enclosure. In the current example, the coupling structure 120 has a plurality of fastener receptacles 122 that are each configured to receive a fastener that fastens the pressure relief assembly 100 to the enclosure. Example fasteners include screws, bolts, pins, and the like. In some embodiments, the coupling structure 120 is defined towards the second axial end 104 of the pressure relief assembly 100.

In some other embodiments, the coupling structure can form a snap-fit connection with the enclosure. In some other embodiments, the coupling structure forms a mating structure that is configured to mate with a corresponding structure defined by the enclosure. For example, the coupling structure can define a screw thread configured to be engaged by the enclosure about the enclosure opening. As another example, the coupling structure can define a connector that interlocks with the enclosure about the enclosure opening, such as a bayonet connector. In some embodiments, the coupling structure can be coupled to the enclosure around the enclosure opening with an adhesive.

In embodiments consistent with the current example, the pressure relief assembly 100 has a sealing region 124 (best visible in FIG. 4). The sealing region 124 is configured to create a seal between the pressure relief assembly 100 and the enclosure when the pressure relief assembly 100 is coupled to the enclosure. The sealing region 124 generally surrounds a portion of the valve airflow pathway. The sealing region 124 surrounds the valve opening 111 in the example currently depicted. In some embodiments, the sealing region 124 surrounds the coupling structure 120. The sealing region 124 can include an elastomeric material configured to make contact with the enclosure. The sealing region 124 can be defined by the frame 110 itself or it can be a separate component, such as a seal 126. In the current example, the sealing region 124 includes a circumferential groove 125 that is configured to receive a seal 126. In some embodiments the sealing region 124 has the seal 126 that is a loop of rubber or another gasketing or sealing material.

The valve mounting surface 112 is generally configured to sealably receive the valve body 130 around the valve opening 111. The valve body 130 selectively obstructs the valve airflow pathway 106. In the current example, the valve body 130 has a sealing surface 114 that is configured to form a seal with the mounting surface 112. In some other embodiments, the valve mounting surface 112 has the sealing surface 114 that is configured to form a seal with the valve body 130. The sealing surface 114 can be an o-ring, for example, or another loop of elastomeric material.

The valve body 130 is generally configured to accommodate pressure release from an enclosure to which the pressure relief assembly 100 is coupled. The valve body 130 is generally configured to accommodate pressure release from the first axial end 102 to the second axial end 104 through the frame 110. The valve body 130 is sealably disposed on the valve mounting surface 112 across the valve opening 111. As such, the valve airflow pathway 106 is obstructed by the valve body 130. The valve body 130 can be constructed of a variety of materials and combinations of materials discussed above and can have properties consistent with those discussed above.

The valve body 130 can have a variety of different shapes, but in the current embodiment the valve body 130 has a circular profile in the lateral direction, where the “lateral direction” is the direction of the plane perpendicular to the axial direction, and the axial direction is the direction of an axis x (FIG. 4) extending between the first axial end 102 to the second axial end 104. In some embodiments the valve body 130 can have a lateral profile that is a polygonal shape such as rectangular, hexagonal, or the like.

The valve body 130 also has at least a first detent 140 that releasably secures the valve body 130 to the frame 110. The first detent 140 is configured to release the valve body 130 from the frame 110 upon a minimum pressure differential across the valve opening 111. In the current example, the valve body 130 has a plurality of detents 140 including the first detent that releasably secures the valve body 130 to the frame 110. The detent(s) 140 can have a variety of configurations. In the current example, each of the detents 140 is a spring-loaded detent. A spring-loaded detent is a detent that employs a compression spring to secure the valve body 130 to the frame 110 and the spring force is overcome by the release force to release the valve body 130 from the frame 110. Each detent 140 extends laterally from the frame 110 to the valve body 130. In the current example, each detent 140 is fixed to the valve body 130 and each detent 140 frictionally engages the frame 110, although the reverse configuration is also possible where each detent 140 is fixed to the frame 110 (or enclosure, where a frame is omitted) and frictionally engages the valve body 130. Furthermore, other types of engagement are possible such as magnetic engagement.

In various embodiments, each detent 140 of the plurality of detents has an identical structure. In the current example, which is best visible in FIG. 4, each detent 140 has a detent housing 142 having a first end 141 and a second end 143. The second end 143 is generally open, and a detent engagement surface 144 protrudes from the second end 143 of the detent housing 142 to frictionally engage a mating surface 145 the frame 110 (or the valve body 130 in a reverse orientation). A compression spring 146 is disposed in the detent housing 142, extending from the first end 141 towards the second end 143. The compression spring 146 is compressed between the first end 141 of the detent housing 142 and the detent engagement surface 144. The compression spring 146 biases the detent engagement surface 144 outward. The detent engagement surface 144 is translatably disposed in the detent housing 142. The compression spring 146 can be a helical coil constructed of metal or plastic, in some embodiments. The compression spring 146 can also be multiple coils, in some embodiments.

When the pressure in an enclosure increases to attain a minimum pressure differential between the enclosure and the outside environment, the force between the frame 110 and the detent engagement surface 144 increases until the biasing force of the compression spring 146 is overcome, causing lateral translation of the detent engagement surface 144 against the compression spring 146, towards the first end of the detent housing 142. The pressure differential between the enclosure and the outside environment results in a force that pushes the valve body 130 out from the valve opening 111, which overcomes the force by the detent 140.

There are various factors that help define the minimum pressure differential that removes the valve body 130 from the valve opening 111. The area of the lateral profile of the valve opening 111, the biasing force of the detents 140, the number of detents 140, the contact angle between the detent engagement surface 144 and the frame 110, the breathability of the valve body 130, the curvature of the detent engagement surface 144 are all example factors that contribute to defining the minimum pressure differential that removes the valve body 130 from the valve opening 111. The minimum pressure differential is not particularly limited, but in some embodiments the minimum pressure differential ranges from 40 mbar (0.58 psi) to 100 mbar (1.45 psi), 50 mbar (0.73 psi) to 90 mbar (1.3 psi), or 60 mbar (0.87 psi) to 80 mbar (1.16 psi). In one particular example the minimum pressure differential ranges from 65 mbar (0.94 psi) to 75 mbar (1.09 psi). However other ranges are certainly contemplated.

The valve body 130 is generally configured to be clear of the valve airflow pathway 106 upon the minimum pressure differential across the valve opening 111, where being “clear” of the valve airflow pathway 106 means that at least 85%, 90%, 95%, or 97% of the lateral area of the valve opening does not overlap with the lateral area of valve body 130 in the axial direction. In some embodiments, there is no overlap between the lateral area of the valve body 130 and 100% of the lateral area of valve opening in the axial direction. Such a configuration may advantageously maximize pressure release from the enclosure to the outside environment. In some such embodiments, the valve body 130 is configured to be ejected from the frame 110 upon the minimum pressure differential across the valve opening 111. In some embodiments, a tether can couple the valve body 130 to the frame 110 such that the valve body 130 remains in proximity of the frame 110 after detachment from the frame 110.

In the current example, the detent engagement surface 144 is defined by a detent ball 148 (FIG. 4) disposed in the detent housing 142. The detent ball 148 can be a sphere rotatably disposed in the detent housing 142 to facilitate release of the valve body 130 by the frame 110. In some other embodiments the detent engagement surface can be defined by a differently-shaped component, such as an ovoid or a cylindrical component with a rounded, convex end forming the detent engagement surface 144. In some other embodiments, the detent engagement surface is concave.

The detents 140 can have alternate configurations, as will be appreciated. In some embodiments the detent(s) is not a spring-loaded detent. For example, the detent can be a protrusion extending laterally outward from the valve body 130 or laterally inward from the frame 110 to engage a corresponding engaging surface of the other of the frame 110 or the valve body 130. In some embodiments each detent is a magnet that secures the valve body 130 to the frame 110.

In the current example the detents 140 are fixed to the valve body 130. More particularly, the valve body 130 defines lateral detent openings 134 (visible in FIG. 3). In this example, the detent openings 134 extend radially outward from the central axis x and are equally spaced around the central axis. Each detent opening 134 is configured to receive and engage a detent housing 142. In particular, the first end 141 of each detent housing 142 is inserted into a detent opening 134. The second end 143 of the detent housing 142 can be positioned outside of the detent opening 134 or inside of the detent opening 134. The detent engagement surface 144 generally is positioned outside of the detent opening 134.

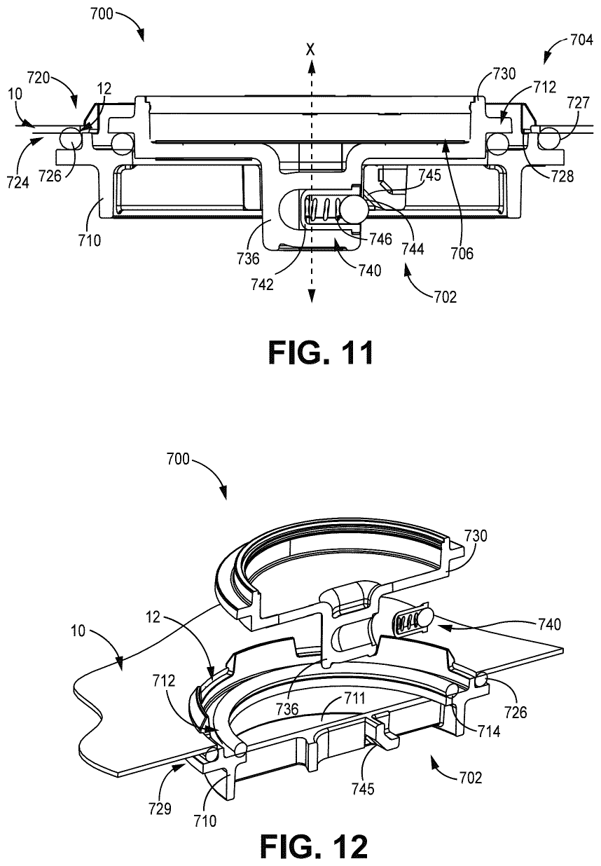

In some other embodiments, the valve body 130 can have a valve stem extending axially outward from the valve body 130. In such an example, the detent can extend laterally from the frame to the valve stem to releasably secure the valve body 130 to the valve mounting surface 112. Such examples are discussed below with reference to FIGS. 11-14.

Some embodiments of the technology disclosed herein may advantageously allow re-use of the pressure relief assembly 100 after release of the valve body 130 from the frame 110. In particular, detents 140 such as spring-loaded detents or magnets, as examples, may be configured to be deployed multiple times without mechanical/physical degradation, which allows for a predictable minimum pressure differential to trigger deployment of the valve body 130. The reusability of the pressure relief assembly 100 may advantageously allow performance testing of every component prior to use by an end customer, for example. The reusability of the pressure relief assembly 100 may advantageously allow re-use by an end customer, as another example.

The frame 110 of the relief valve assembly 200 cam be constructed of a variety of materials and combinations of materials. In some embodiments, the frame 110 is constructed of a breathable porous plastic material. In some embodiments, the frame 110 is breathable. In some embodiments, the frame 110 has pore sizes consistent with the pore sizes of the valve body 130. In some embodiments, the frame 110 has a void volume consistent with the void volume of the valve body 130. In some other embodiments, the frame 110 is constructed of non-porous plastic such an injection-molded thermoplastic, as an example. In some other examples the frame 110 is constructed of another material such as metal.

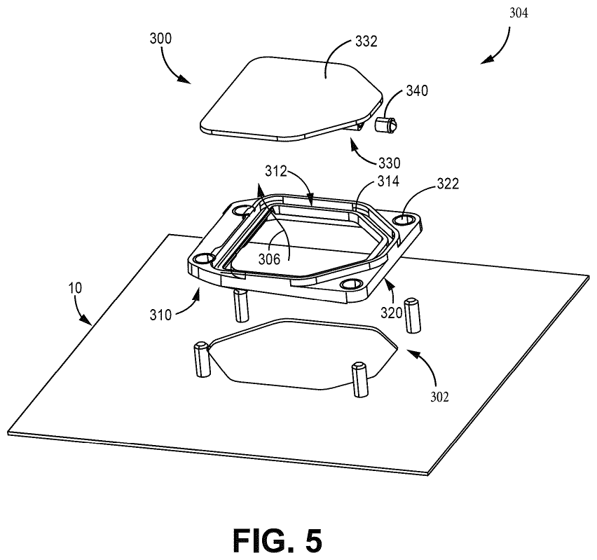

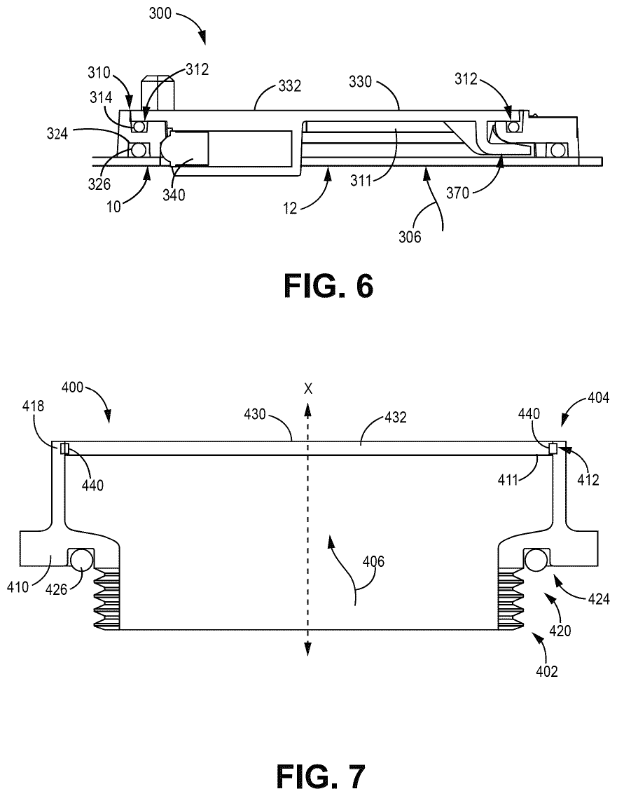

FIGS. 5 and 6 depict another example of a pressure relief assembly 300 consistent with the technology disclosed herein. FIG. 5 is an exploded perspective view of the pressure relief assembly 300 and FIG. 6 is a cross-sectional view. The present figures also depict an example enclosure 10, which the pressure relief assembly 300 is configured to be coupled to. As with the examples discussed above, the pressure relief assembly 300 is generally configured to be coupled to the enclosure 10 about an enclosure opening 12. The pressure relief assembly 300 generally has a first axial end 302, a second axial end 304, and a valve airflow pathway 306 extending from the first axial end 302 through the second axial end 304. The valve airflow pathway 306 is selectively obstructed by a valve body 330, where the valve body 330 is configured to relieve pressure when the pressure within the enclosure relative to the outside environment exceeds a minimum pressure differential.

In the current example, the pressure relief assembly 300 has a frame 310 and the valve body 330 is coupled to the frame 310. In some other embodiments, however, the frame 310 is omitted and the enclosure can be configured to be coupled to the valve body 330. The frame 310 has a coupling structure 320, a valve mounting surface 312, and a valve opening 311 within the valve mounting surface 312. The valve airflow pathway 306 selectively extends through the valve opening 311. Components of the pressure relief assembly 300 are generally consistent with the descriptions of the same components discussed elsewhere herein, unless contrary to the current description.

The coupling structure 320 is generally configured to sealably couple to an enclosure about an enclosure opening. The coupling structure 320 is generally configured to engage the enclosure. In the current example, the coupling structure 320 has a plurality of fastener receptacles 322 that are each configured to receive a fastener that fastens the pressure relief assembly 300 to the enclosure. In some embodiments, the coupling structure 320 is defined towards the first axial end 302 of the pressure relief assembly 300. The coupling structure 320 can include a sealing region 324 configured to accommodate a seal, such as a sealing loop 326, between the pressure relief assembly 300 and the enclosure when the pressure relief assembly 300 is coupled to the enclosure. The sealing region 324 can surround the valve opening 311, such as in the example currently depicted. The sealing region 324 surrounds the valve airflow pathway 306. The coupling structure 320, including the sealing region(s) 324 can have configurations and alternate configurations that have been described above.

The valve mounting surface 312 is generally configured to sealably receive the valve body 330 around the valve opening 311. The valve body 330 selectively obstructs a valve airflow pathway 306. In the current example, the valve mounting surface 312 includes a sealing surface 314 (FIG. 6) that is configured to form a seal with the valve body 330. In some other embodiments, the valve body 330 itself can include the sealing surface 314 that is configured to form a seal with the valve mounting surface 312. In embodiments omitting the frame 310, the sealing surface 314 can be configured to form a seal with the enclosure about the valve opening.

The valve body 330 is generally configured to accommodate pressure release from the enclosure 10. The valve body 330 is generally configured to accommodate pressure release from the first axial end 302 to the second axial end 304 through the frame 310. The valve body 330 is sealably disposed on the valve mounting surface 312 across the valve opening 311 such that the valve airflow pathway 306 is obstructed by the valve body 330. The valve body 330 can be consistent with valve bodies described in detail above. It is noted that in the current example, however, the valve body 330 has a different profile shape in the lateral direction than in the example of FIGS. 1-4. While the valve body 330 of FIGS. 1-4 has a circular profile shape, here the valve body 330 has a profile shape in the lateral direction that is polygonal.

In the present example, the valve body 330 has a first detent 340 that releasably secures the valve body 330 to the frame 310. The first detent 340 is configured to release the valve body 330 from the frame 310 upon a minimum pressure differential across the valve opening 311. In the current example, the valve body 330 has a single detent 340. The detent 340 is fixed to a first lateral end of the valve body 330. An engagement surface on the detent 340 frictionally engages the frame, although the reverse configuration is possible where the detent 340 is fixed to the frame and frictionally engages the valve body 330. Furthermore, other forces can engage the frame or the valve body 330, such as magnetic forces. In the current example the detent 340 is a spring-loaded detent, but the detent 340 can have alternate configurations described above. Furthermore, in some embodiments the pressure relief assembly can include additional detents 340 that releasably couple the valve body 332 to the frame.

In the current example, the pressure relief assembly has a hinge 370 that pivotably couples the valve body 330 to the frame 310. In embodiments omitting the frame, the hinge 370 can be configured to pivotably couple the valve body 330 to the enclosure. The hinge 370 generally defines the translation path of the valve body 330. The hinge 370 is generally configured to accommodate pivoting of the valve body 330 upon deployment of the detent(s) 340 and the application of pressure on the surface of the valve body 330 in communication with the enclosure, such as the force resulting from a minimum pressure differential across the valve body 330. The valve body 330 is generally pivotable outward relative to the enclosure.

In the current example, the hinge 370 is positioned oppositely of the first detent 340 relative to the valve body 330 in the lateral direction. The hinge 370 is positioned on a second lateral end of the valve body 330 that is opposite the first lateral end of the valve body 330. In the current example, the hinge 370 is mutually defined by reciprocal structures of the frame 310 and the valve body 330, but in other embodiments the hinge 370 can be a separate component that pivotably couples the valve body 330 and the frame 310.

When pressure inside the enclosure spikes above a minimum pressure differential between inside the enclosure and the outside environment, the pressure inside the enclosure pushes against the enclosure side of the valve body 330, which deploys the detent 340 (similar to the discussion above) to release the first lateral end of the valve body 330 from the frame 310. The valve body 330 then pivots in response to the pressure in a direction away from the enclosure to clear the valve airflow pathway 306 and allow pressure equalization between inside the enclosure and the outside environment.

In some embodiments, the valve body 330 is generally configured to be clear of the valve airflow pathway 306 upon the minimum pressure differential across the valve opening 311. Such a configuration may advantageously maximize pressure release from the enclosure to the outside environment. In the current example, however, the valve body 330 is configured to remain coupled to the frame 310 via the hinge 370 upon the minimum pressure differential across the valve opening 311.

FIG. 7 is a schematic cross-sectional view of yet another pressure relief assembly 400 consistent with the technology disclosed herein. As with the examples discussed above, the pressure relief assembly 400 is generally configured to be coupled to the enclosure about an opening in the enclosure. The pressure relief assembly 400 generally has a first axial end 402, a second axial end 404, and a valve airflow pathway 406 extending from the first axial end 402 through the second axial end 404. The valve airflow pathway 406 is selectively obstructed by a valve body 430, where the valve body 430 is configured to relieve pressure when the pressure differential between the inside of the enclosure and the outside environment exceeds a minimum pressure differential. Components of the pressure relief assembly 400 are generally consistent with the descriptions of the same components discussed elsewhere herein, unless contrary to the current description.

The pressure relief assembly 400 has a frame 410 and a valve body 430 coupled to the frame 410. The frame 410 has a coupling structure 420, a valve mounting surface 412, and a valve opening 411 within the valve mounting surface 412. The valve airflow pathway 406 selectively extends through the valve opening 411. The axis x can be a central axis of the frame in some embodiments.

More particularly, in the current example the frame 410 has a valve sidewall 418 that extends in the axial direction between the first axial end 402 and the second axial end 404. The valve sidewall 418 extends in the axial direction between the coupling structure 420 and the valve body 430, and more particularly from the coupling structure 420 to the valve mounting surface 412. The valve sidewall 418 surrounds the valve airflow pathway 406. While the valve sidewall 418 is perpendicular to the valve opening 411, in some embodiments the valve sidewall 418 can form a different angle with the valve opening 411.

The coupling structure 420 is generally configured to sealably couple to an enclosure about an enclosure opening. The coupling structure 420 is generally configured to engage the enclosure. In the current example, the coupling structure 420 includes a threaded portion extending axially from the frame that is configured to rotatably engage a mating inner circumferential surface of an enclosure about an enclosure opening. In this example, the coupling structure 420 is defined towards the first axial end 402 of the pressure relief assembly 400. The coupling structure 420 includes a sealing region 424 configured to accommodate a sealing loop 426 between the pressure relief assembly 400 and the enclosure when the pressure relief assembly 400 is coupled to the enclosure. The sealing region 424 generally surrounds the valve airflow pathway 406. In the current example, the sealing region 424 surrounds the threaded extension. The coupling structure 420, including the sealing region(s) 424 can have alternative configurations that have been described above.

The valve mounting surface 412 is generally configured to sealably receive the valve body 430 around the valve opening 411. In the current example the valve mounting surface 412 is an inner perimetric surface surrounding the valve airflow pathway 406. In some embodiments the valve mounting surface 412 is an inner circumferential surface. The valve body 430 selectively obstructs a valve airflow pathway 406 across the valve opening 411. In the current example, the valve mounting surface 412 and the valve body 430 form a seal around the valve opening 411.

The valve body 430 is generally configured to accommodate pressure release from the enclosure. The valve body 430 is generally configured to accommodate pressure release from the first axial end 402 to the second axial end 404 through the frame 410. The valve body 430 is sealably disposed on the valve mounting surface 412 across the valve opening 411 such that the valve airflow pathway 406 is obstructed by the valve body 430.

In the present example, the valve body 430 has a plurality of detents 440 that releasably secure the valve body 432 to the frame 410. The detents are configured to release the valve body 432 from the frame 410 upon a minimum pressure differential across the valve opening 411. The detents 440 are disposed around an outer perimetric surface, such as an outer circumferential surface, of the valve body 432. In the current example each of the detents 440 is a magnetic component that is configured to magnetically engage a magnetic mating surface of the valve mounting surface 412. An engagement surface on each detent 440 magnetically engages the frame. Alternative types of detents can also be used.

In some examples, although not currently visible, a hinge can pivotably couple the valve body 432 to the frame. In such an example the hinge can define the translation path of the valve body 432. The hinge is generally configured to accommodate pivoting of the valve body 432 upon the application of pressure on the surface of the valve body 432 in communication with the enclosure, such as the force resulting from a minimum pressure differential across the valve body 432, and deployment of the detent(s). The valve body 432 is generally pivotable outward relative to the enclosure. In embodiments incorporating a hinge, the hinge can be positioned oppositely of one or more detents 440 relative to the valve body 432 in the lateral direction.

When pressure inside the enclosure spikes above a minimum pressure differential between inside the enclosure and the outside environment, the pressure inside the enclosure pushes against the enclosure side of the valve body 432, which deploys the detent 440 (similar to the discussion above) to decouple the valve body 432 from the valve mounting surface 412. The valve body 432 can either be released from the frame or, in embodiments incorporating a hinge, can pivot in response to the pressure in a direction away from the enclosure to clear the valve airflow pathway 406 and allow pressure equalization between inside the enclosure and the outside environment.

In some embodiments, the valve body 432 is generally configured to be clear of the valve airflow pathway 406 upon the minimum pressure differential across the valve opening 411. Such a configuration may advantageously maximize pressure release from the enclosure to the outside environment. In the current example, however, the valve body 432 is configured to remain coupled to the frame 410 via the hinge despite upon the minimum pressure differential across the valve opening 411.

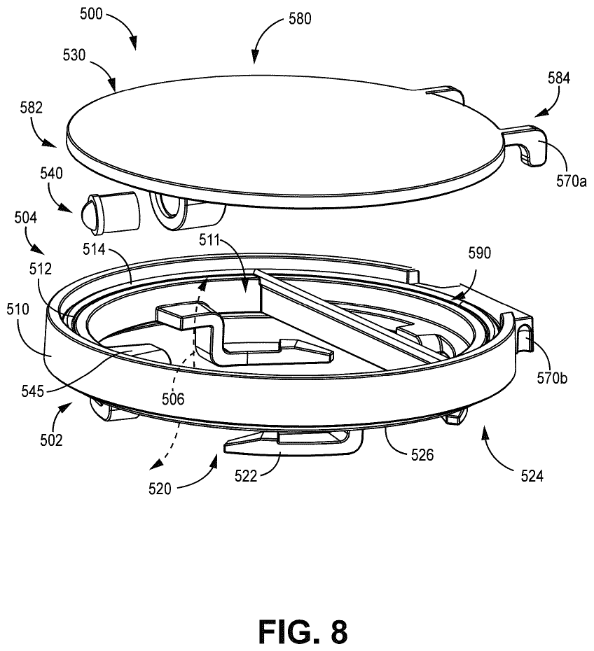

FIG. 8 depicts an exploded view of yet another example of a pressure relief assembly 500 consistent with the technology disclosed herein. As with the examples discussed above, the pressure relief assembly 500 is generally configured to be coupled to the enclosure about an enclosure opening. The pressure relief assembly 500 generally has a first axial end 502, a second axial end 504, and a valve airflow pathway 506 extending from the first axial end 502 through the second axial end 504. The valve airflow pathway 506 is selectively obstructed by a valve body 530, where the valve body 530 is configured to relieve pressure when the pressure within the enclosure relative to the outside environment exceeds a minimum pressure differential. Components of the pressure relief assembly 500 are generally consistent with the descriptions of the same components discussed elsewhere herein, unless contrary to the current description.

The pressure relief assembly 500 has a frame 510 and the valve body 530 is coupled to the frame 510. The frame 510 is generally configured to support one or more components of the pressure relief assembly 500. The frame 510 has a coupling structure 520, a valve mounting surface 512, and a valve opening 511 within the valve mounting surface 512. The valve airflow pathway 506 selectively extends through the valve opening 511.

The coupling structure 520 is generally configured to sealably couple to an enclosure about an enclosure opening. The coupling structure 520 is generally configured to engage the enclosure. In the current example, the coupling structure 520 has a bayonet connector 522 that is configured to be received by a mating bayonet connector defined by an enclosure. In this example, the coupling structure 520 is defined towards the first axial end 502 of the pressure relief assembly 500. The coupling structure 520 can include a sealing region 524 configured to accommodate a seal, such as a sealing loop 526, between the pressure relief assembly 500 and the enclosure when the pressure relief assembly 500 is coupled to the enclosure. The sealing region 524 can surround the valve opening 511, such as in the example currently depicted. The sealing region 524 surrounds the valve airflow pathway 506. In the current example, the sealing region 524 surrounds the valve opening. The coupling structure 520, including the sealing region(s) 524 can have configurations and alternate configurations that have been described above.

The valve mounting surface 512 is generally configured to sealably receive the valve body 530 around the valve opening 511. The valve body 530 selectively obstructs a valve airflow pathway 506. In the current example, the valve mounting surface 512 includes a sealing surface 514 that is configured to form a seal with the valve body 530. In some other embodiments, the valve body 530 itself can include the sealing surface that is configured to form a seal with the valve mounting surface 512.

In the current example, the pressure relief assembly 500 has a sealing ring 590 that is coupled to the frame 510. It is noted that the term “ring” does not necessarily mean a component having a circular shape, although the sealing ring certainly could have a circular shape. Rather, the term “ring” is used herein to refer to structures having a central opening and material completely surrounding the central opening. The sealing ring 590 has a first axial end that is the sealing loop 526 and a second axial end that forms a perimetric sealing surface around the valve opening 511. A portion of the perimetric sealing surface defines a portion of the sealing surface 514 between the valve body 530 and the frame 510. In some embodiments, the frame 510 can be overmolded to the sealing ring 590. In some embodiments, the sealing ring 590 can have a series of discrete axial extension portions extending between the first axial end 502 and the second axial end 504. The discrete axial extension portions can be radially spaced around a central axis.

The valve body 530 is generally configured to accommodate pressure release from an enclosure. The valve body 530 is generally configured to accommodate pressure release from the first axial end 502 to the second axial end 504 through the frame 510. The valve body 530 has a valve body 530 sealably disposed on the valve mounting surface 512 across the valve opening 511 such that the valve airflow pathway 506 is obstructed by the valve body 530. The valve body 530 can be consistent with valve bodies described in detail above.

In the present example, the valve body 530 has a first detent 540 that releasably secures the valve body 530 to the frame 510. The first detent 540 is configured to release the valve body 530 from the frame 510 upon a minimum pressure differential across the valve opening 511. In the current example, the valve body 530 has a single detent 540. The detent 540 is fixed to the valve body 530. An engagement surface on the detent 540 frictionally engages a mating surface 545 of the frame 510, although the reverse configuration is possible where the detent 540 is fixed to the frame and frictionally engages the cap 580 and/or the valve body 530. Furthermore, a detent can employ additional or different forces to engage the frame 510 and the valve body 530, such as magnetic forces. In the current example the detent 540 is a spring-loaded detent, but the detent 540 can have alternate configurations described above. Furthermore, in some embodiments the pressure relief assembly can include additional detents 540 that releasably couple the valve body 530 to the frame.

In the current example, the pressure relief assembly has a hinge 570a, 570b that pivotably couples the valve body 530 to the frame 510. The hinge 570a, 570b generally defines the translation path of the valve body 530. The hinge 570a, 570b is generally configured to accommodate pivoting of the cap 580, and in particular the valve body 530 upon the application of pressure on the surface of the valve body 530 in communication with the enclosure, such as the force resulting from a minimum pressure differential across the valve body 530, which results in deployment of the detent(s) 540. The cap 580 is generally pivotable outward relative to the enclosure.

In the current example, the hinge 570a, 570b is positioned oppositely of the first detent 540 relative to the valve body 530 in the lateral direction. The hinge 570a, 570b is positioned on a second lateral end 584 of the cap 580, and therefore the valve body 530, that is opposite a first lateral end 582 of the cap 580. In the current example, the hinge 570a, 570b is mutually defined by reciprocal structures of the frame 510 and the cap 580. In some embodiments the hinge 570a, 570b can be a separate component that pivotably couples the cap 580 and the frame 510.

When pressure inside the enclosure (to which the pressure relief assembly 500 is coupled) spikes above a minimum pressure differential between inside the enclosure and the outside environment, the pressure inside the enclosure pushes against the enclosure side of the cap 580/valve body 530, which deploys the detent 540 (similar to the discussion above) to decouple the first lateral end 582 of the valve body 530 and the frame 510. The valve body 530 then pivots in response to the pressure in a direction away from the enclosure to clear the valve airflow pathway 506 and allow pressure equalization between inside the enclosure and the outside environment.

In some embodiments, the valve body 530 is generally configured to be clear of the valve airflow pathway 506 upon the minimum pressure differential across the valve opening 511. Such a configuration may advantageously maximize pressure release from the enclosure to the outside environment. In the current example, however, the valve body 530 is configured to remain coupled to the frame 510 via the hinge 570a, 570b upon the minimum pressure differential across the valve opening 511.

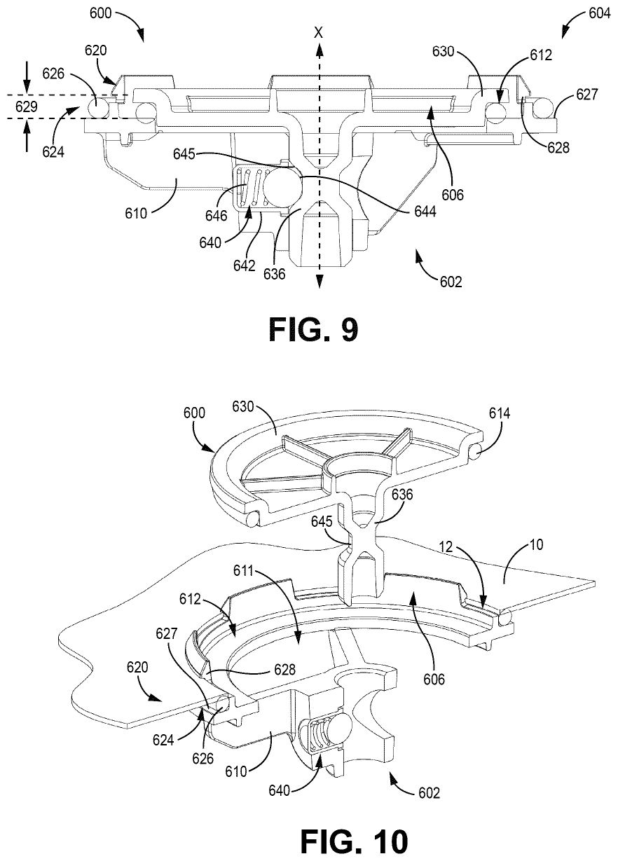

FIGS. 9 and 10 depict another example of a pressure relief assembly 600 consistent with the technology disclosed herein. FIG. 11 is a cross-sectional view of the pressure relief assembly 600 and FIG. 12 is an exploded perspective cross-sectional view of the pressure relief assembly 600. The present figures also depict an example enclosure 10, which the pressure relief assembly 600 is configured to be coupled to. As with the examples discussed above, the pressure relief assembly 600 is generally configured to be coupled to the enclosure 10 about an enclosure opening 12. The pressure relief assembly 600 generally has a first axial end 602, a second axial end 604, and a valve airflow pathway 606 extending from the first axial end 602 through the second axial end 604. The valve airflow pathway 606 is selectively obstructed by a valve body 630, where the valve body 630 is configured to relieve pressure when the pressure within the enclosure relative to the outside environment exceeds a minimum pressure differential. Components of the pressure relief assembly 600 are generally consistent with the descriptions of the same components discussed elsewhere herein, unless contrary to the current description.

The pressure relief assembly 600 has a frame 610 and the valve body 630 is coupled to the frame 610. The frame 610 is generally configured to support one or more components of the pressure relief assembly 600. The frame 610 has a coupling structure 620, a valve mounting surface 612, and a valve opening 611 within the valve mounting surface 612. The valve airflow pathway 606 selectively extends through the valve opening 611.

The coupling structure 620 is generally configured to sealably couple to the enclosure 10 about an enclosure opening 12. The coupling structure 620 is generally configured to engage the enclosure 10. The coupling structure 620 is defined towards the second axial end 604 of the pressure relief assembly 600. In the current example, the coupling structure 620 is configured to form a compression fit with the enclosure 10 around the enclosure opening 12. The coupling structure 620 can include a sealing region 624 configured to accommodate a seal, such as a sealing loop 626, between the pressure relief assembly 600 and the enclosure 10 when the pressure relief assembly 600 is coupled to the enclosure 10. The sealing region 624 can surround the valve opening 611. The sealing region 624 surrounds the valve airflow pathway 606. In the current example, the sealing region 624 surrounds the valve opening 611.

In the current example, the coupling structure 620 includes an inner retaining rim 627 and an outer retaining rim 628 that each extend radially outward from the frame 610. The inner retaining rim 627 is configured to be positioned within the enclosure 10. The outer retaining rim 628 is configured to be positioned outside of the enclosure 10. The inner retaining rim 627 and the outer retaining rim 628 form a perimetric gap 629 extending in the axial direction that is configured to receive the wall of the enclosure 10 around the enclosure opening 12. The perimetric gap 629 is configured to compressibly receive the wall of the enclosure 10 and the sealing loop 626. In the current example, the outer retaining rim 628 is a plurality of discrete sections spaced perimetrically around the frame 610, but in other examples, the outer retaining rim 628 can be a single cohesive component extending perimetrically around the frame 610.

The coupling structure 620, including the sealing region(s) 624 can have configurations and alternate configurations that have been described above. For example, in some other embodiments, similar to examples described above, the coupling structure 620 can have a plurality of fastener receptacles that are each configured to receive a fastener that fastens the pressure relief assembly 600 to the enclosure.

The valve mounting surface 612 is generally configured to sealably receive the valve body 630 around the valve opening 611. The valve body 630 selectively obstructs a valve airflow pathway 606. In the current example, the valve body 630 itself can include the sealing surface 614 that is configured to form a seal with the valve mounting surface 612. In some other embodiments, the valve mounting surface 612 includes the sealing surface 614 that is configured to form a seal with the valve body 630.

The valve body 630 is generally configured to accommodate pressure release from the enclosure 10. The valve body 630 is generally configured to accommodate pressure release from the first axial end 602 to the second axial end 604 through the frame 610. The valve body 630 has a valve body 630 sealably disposed on the valve mounting surface 612 across the valve opening 611 such that the valve airflow pathway 606 is obstructed by the valve body 630. The valve body 630 can be consistent with valve bodies described in detail above. In the current example the has a circular profile shape in the lateral direction, but the valve body 630 has an alternate profile shape such as polygonal.

In the present example, the pressure relief assembly 600, and in particular the frame 610, has a first detent 640 that releasably secures the valve body 630 to the frame 610. The first detent 640 is configured to release the valve body 630 from the frame 610 upon a minimum pressure differential across the valve opening 611. In the current example, the assembly 600 has a single detent 640. The detent 640 is fixed to the frame 610. An engagement surface 644 on the detent 640 frictionally engages the valve body 630, although the reverse configuration is possible where the detent 640 is fixed to the valve body 630 and frictionally engages the frame 610. Furthermore, different or additional forces can engage the frame 610 and the valve body 630, such as magnetic forces. In the current example the detent 640 is a spring-loaded detent and has a similar configuration to that described above with reference to FIGS. 1-4, but the detent 640 can have alternate configurations that are also described above. Furthermore, in some embodiments the pressure relief assembly can include additional detents 640 that releasably couple the valve body 630 to the frame 610.

In the current example, the valve body 630 has the valve body 630 and a valve stem 636. The valve stem 636 extends outward axially from the valve body 630 towards the first end 602 of the assembly 600. The valve stem 636 defines a mating surface 645 that is frictionally engaged by the engagement surface 644 of the detent 640. When the pressure in the enclosure 10 increases to attain a minimum pressure differential between the enclosure 10 and the outside environment, the force between the valve body 630 and the detent engagement surface 644 increases until the biasing force of the compression spring 646 is overcome, causing lateral translation of the detent engagement surface 644 against a compression spring 646, towards a first end of the detent housing 642. The pressure differential between the enclosure 10 and the outside environment results in a force that pushes the valve body 630 out from the valve opening 611, which is unopposed by the detent 640. The valve body 630 is ejected from the frame 610 in response to the pressure differential, in a direction away from the enclosure 10 to clear the valve airflow pathway 606 and allow pressure equalization between inside the enclosure 10 and the outside environment. In some embodiments, the valve body 630 is configured to be clear of the valve airflow pathway 606 upon the minimum pressure differential across the valve opening 611.

FIGS. 11 and 12 depict yet another example of a pressure relief assembly 700 consistent with the technology disclosed herein. FIG. 11 is a cross-sectional view of the pressure relief assembly 700 and FIG. 12 is an exploded perspective cross-sectional view of the pressure relief assembly 700. The present figures also depict an example enclosure 10, which the pressure relief assembly 700 is configured to be coupled to. As with the examples discussed above, the pressure relief assembly 700 is generally configured to be coupled to the enclosure 10 about an enclosure opening 12. The pressure relief assembly 700 generally has a first axial end 702, a second axial end 704, and a valve airflow pathway 706 extending from the first axial end 702 through the second axial end 704. The valve airflow pathway 706 is selectively obstructed by a valve body 730, where the valve body 730 is configured to relieve pressure when the pressure within the enclosure relative to the outside environment exceeds a minimum pressure differential. Components of the pressure relief assembly 700 are generally consistent with the descriptions of the same components discussed elsewhere herein, unless contrary to the current description.

The pressure relief assembly 700 has a frame 710 and the valve body 730 is coupled to the frame 710. The frame 710 is generally configured to support one or more components of the pressure relief assembly 700. The frame 710 has a coupling structure 720, a valve mounting surface 712, and a valve opening 711 (FIG. 12) within the valve mounting surface 712. The valve airflow pathway 706 selectively extends through the valve opening 711.

The coupling structure 720 is generally configured to sealably couple to the enclosure 10 about an enclosure opening 12. The coupling structure 720 is generally configured to engage the enclosure 10 and can be consistent with other coupling structures, and modifications thereof, described elsewhere herein. Similar to the description of FIGS. 11-12, the coupling structure 720 is configured to form a compression fit with the enclosure 10 around the enclosure opening 12. The coupling structure 720 can include a sealing region 724 configured to accommodate a seal, such as a sealing loop 726, between the pressure relief assembly 700 and the enclosure 10 when the pressure relief assembly 700 is coupled to the enclosure 10. The coupling structure 720 has an inner retaining rim 727 and an outer retaining rim 728 that each extend radially outward from the frame 710 and form a perimetric gap 729 extending in the axial direction that is configured to receive the wall of the enclosure 10 around the enclosure opening 12. The perimetric gap 729 is configured to compressibly receive the wall of the enclosure 10 and the sealing loop 726.

The valve mounting surface 712 is configured to sealably receive the valve body 730 around the valve opening 711. In the current example, the valve mounting surface 712 includes a sealing surface 714 that is configured to form a seal with the valve body 730. In some other embodiments, the valve body 730 itself can include the sealing surface 714 that is configured to form a seal with the valve mounting surface 712.

The valve body 730 is generally configured to accommodate pressure release from the enclosure 10. The valve body 730 is generally configured to accommodate pressure release from the first axial end 702 to the second axial end 704 through the frame 710. The valve body 730 is disposed on the valve mounting surface 712 across the valve opening 711 such that the valve airflow pathway 706 is obstructed by the valve body 730. The valve body 730 can be consistent with valve bodies described in detail above. In the current example the has a circular profile shape in the lateral direction, but the valve body 730 has an alternate profile shape such as a polygonal profile shape.

In the current example, the pressure relief assembly 700, and in particular the valve body 730, has a first detent 740 that releasably secures the valve body 730 to the frame 710. The first detent 740 is configured to release the valve body 730 upon a minimum pressure differential across the valve opening 711. In the current example, the assembly 700 has a single detent 740. The detent 740 is fixed to the valve body 730. An engagement surface 744 on the detent 740 frictionally engages the frame 710, although the reverse configuration is possible where the detent 740 is fixed to the frame 710 and frictionally engages the valve body 730, an example of which is described above. Furthermore, different or additional forces can engage the frame 710 and the valve body 730, such as magnetic forces. In the current example the detent 740 is a spring-loaded detent and has a similar configuration to that described above with reference to FIGS. 2-4, but the detent 740 can have alternate configurations that are also described above. Furthermore, in some embodiments the pressure relief assembly can include additional detents 740 that releasably couple the valve body 730 to the frame 710.

In the current example, the valve body 730 has the valve body 730 and a valve stem 736. The valve stem 736 extends outward in the axial direction from the valve body 730 towards the first end 702 of the assembly 700. The valve stem 736 defines a detent receptacle that the detent 740 is fixed to. The frame 710 has a mating surface 745 that is frictionally engaged by the engagement surface 744 of the detent 740. When the pressure in the enclosure 10 increases to attain a minimum pressure differential between the enclosure 10 and the outside environment, the force between the frame 710 and the detent engagement surface 744 increases until the biasing force of the compression spring 746 is overcome, causing lateral translation of the detent engagement surface 744 against a compression spring 746, towards a first end of the detent housing 742. The pressure differential between the enclosure 10 and the outside environment results in a force that pushes the valve body 730 out from the valve opening 711, which overcomes the force exerted by the detent 740 to maintain engagement between the valve body 730 and the frame 710. The valve body 730 is ejected from the frame 710 in response to the pressure differential, in a direction away from the enclosure 10 to clear the valve airflow pathway 706 and allow pressure equalization between inside the enclosure 10 and the outside environment. In some embodiments, the valve body 730 is configured to be clear of the valve airflow pathway 706 upon the minimum pressure differential across the valve opening 711.

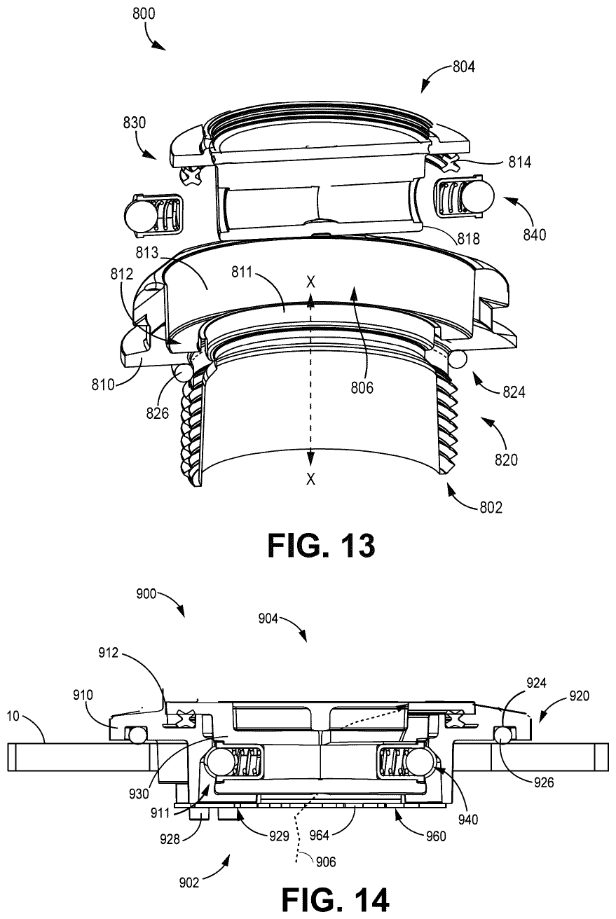

FIG. 13 depicts yet another example of a pressure relief assembly 800 consistent with the technology disclosed herein. FIG. 13 is an exploded perspective cross-sectional view of the pressure relief assembly 800. As with the examples discussed above, the pressure relief assembly 800 is generally configured to be coupled to the enclosure about an opening in the enclosure. The pressure relief assembly 800 generally has a first axial end 802, a second axial end 804, and a valve airflow pathway 806 extending from the first axial end 802 through the second axial end 804. The valve airflow pathway 806 is selectively obstructed by a valve body 830, where the valve body 830 is configured to relieve pressure when the pressure differential between the inside of the enclosure and the outside environment exceeds a minimum pressure differential. Components of the pressure relief assembly 800 are generally consistent with the descriptions of the same components discussed elsewhere herein, unless contrary to the current description.

The pressure relief assembly 800 has a frame 810 and the valve body 830 is coupled to the frame 810. The frame 810 is generally configured to support one or more components of the pressure relief assembly 800. The frame 810 has a coupling structure 820.

In the current example, the frame 810 defines a valve opening 811. The valve airflow pathway 806 selectively extends through the valve opening 811. Unlike some embodiments described elsewhere herein, in the current example, the valve body 830 has a valve sidewall 818 that extends in the axial direction between the first axial end 802 and the second axial end 804. The axis x can be a central axis of the frame 810 in some embodiments.

The coupling structure 820 is generally configured to sealably couple to the enclosure about an enclosure opening, and can be consistent with other coupling structures, and modifications thereof, described elsewhere herein. The coupling structure 820 is generally configured to engage the enclosure. The coupling structure 820 includes a sealing region 824 configured to accommodate a sealing loop 826 between the pressure relief assembly 800 and the enclosure when the pressure relief assembly 800 is coupled to the enclosure. In the current example, the coupling structure 820 includes a threaded portion extending axially from the sealing region 824. The threaded portion is configured to rotatably engage a mating inner circumferential surface of an enclosure about an enclosure opening. In this example, the coupling structure 820 is defined towards the first axial end 802 of the pressure relief assembly 800. The sealing region 824 generally surrounds the valve airflow pathway 806. In the current example, the sealing region 824 surrounds the threaded extension. The coupling structure 820, including the sealing region(s) 824 can have alternative configurations that have been described above.

In the current example, the frame 810 also defines a valve mounting surface 812. The valve mounting surface 812 is configured to sealably receive the valve body 830 around the valve opening 811. In the current example the valve mounting surface 812 can be consistent with valve mounting surfaces described in detail above. The valve body 830 selectively obstructs the valve airflow pathway 806. In the current example, the valve body 830 includes a sealing surface 814 that is configured to form a seal with the valve mounting surface 812. In some other embodiments, the valve mounting surface 812 includes the sealing surface 814 that is configured to form a seal with the valve body 830.

The valve body 830 is generally configured to accommodate pressure release from the enclosure. The valve body 830 is generally configured to accommodate pressure release from the first axial end 802 to the second axial end 804 through the frame 810. The valve body 830 is sealably disposed on the valve mounting surface 812 across the valve opening 811 such that the valve airflow pathway 806 is obstructed by the valve body 830. The valve body 830 can be consistent with valve bodies described in detail above.

In the present example, the valve body 830 has a plurality of detents 840 that releasably secure the valve body 830 to the frame 810. The detents are configured to release the valve body 830 from the frame 810 upon a minimum pressure differential across the valve opening 811. The detents 840 are disposed around an outer perimetric surface, such as an outer circumferential surface, of the valve body 830. The detent(s) 840 can have a variety of configurations. In the current example, each of the detents 840 is a spring-loaded detent. A spring-loaded detent is a detent that employs a compression spring to secure the valve body 830 to the frame 810 and the spring force is overcome by the release force to release the valve body 830 from the frame 810. Each detent 840 extends laterally from the frame 810 to the valve body 830. In the current example, each detent 840 is fixed to the valve body 830 and each detent 840 frictionally engages the frame 810, although the reverse configuration is also possible where each detent 840 is fixed to the frame 810 and frictionally engages the valve body 830. Furthermore, other types of engagement are possible such as magnetic engagement. Each detent 840 can have alternative configurations that have been described above.

In the current example, the detents 840 releasably secure the valve body 830 to the frame 810. In some examples, although not currently visible, a hinge can pivotably couple the valve body 830 to the frame 810. The hinge can be consistent with hinges described in detail above.

When pressure inside the enclosure spikes above a minimum pressure differential between inside the enclosure and the outside environment, the pressure inside the enclosure pushes against the enclosure side of the valve body 830, which deploys the detent 840 (similar to the discussion above) to decouple the valve body 830 from the valve mounting surface 812. The valve body 830 can either be released from the frame 810 or, in embodiments incorporating a hinge, can pivot in response to the pressure in a direction away from the enclosure to clear the valve airflow pathway 806 and allow pressure equalization between inside the enclosure and the outside environment.

In the present example, the frame 810 has a frame sidewall 813. The frame sidewall 813 is positioned radially outward from the valve sidewall 818. The frame sidewall 813 surrounds the valve sidewall 818. In the current example, the valve sidewall 818 and the frame sidewall 813 share a central axis. In the current example, the valve sidewall 818 and the frame sidewall 813 are spaced via a radial gap between them.

In some embodiments, the valve body 830 is generally configured to be clear of the valve airflow pathway 806 upon the minimum pressure differential across the valve opening 811. Such a configuration can be consistent with valve bodies described in detail above.

FIG. 14 depicts yet another example of a pressure relief assembly 900 consistent with the technology disclosed herein. As with the examples discussed above, the pressure relief assembly 900 is generally configured to be coupled to an enclosure 10 about an opening 12 in the enclosure 10. The pressure relief assembly 900 generally has a first axial end 902, a second axial end 904, and a valve airflow pathway 906 extending from the first axial end 902 through the second axial end 904. The valve airflow pathway 906 is selectively obstructed by a valve body 930, where the valve body 930 is configured to relieve pressure when the pressure differential between the inside of the enclosure and the outside environment exceeds a minimum pressure differential. Components of the pressure relief assembly 900 are generally consistent with the descriptions of the same components discussed elsewhere herein, unless contrary to the current description.

The pressure relief assembly 900 has a frame 910 and the valve body 930 is coupled to the frame 910. The frame 910 is generally configured to support one or more components of the pressure relief assembly 900. The frame 910 has a coupling structure 920. The coupling structure 920 can be consistent with coupling structures described in detail above.

In the current example, the frame 910 defines a valve opening 911. The valve airflow pathway 906 selectively extends through the valve opening 911.

The coupling structure 920 is generally configured to sealably couple to the enclosure 10 about an enclosure opening 12, and can be consistent with other coupling structures, and modifications thereof, described elsewhere herein. The coupling structure 920 is generally configured to engage the enclosure 10. In the current example, similar to the description of FIG. 9, the coupling structure 920 has a bayonet connector that is configured to be received by a mating bayonet connector defined by the enclosure 10. In this example, the coupling structure 920 is defined towards the first axial end 902 of the pressure relief assembly 900. The coupling structure 920 can include a sealing region 924 configured to accommodate a seal, such as a sealing loop 926, between the pressure relief assembly 900 and the enclosure 10 when the pressure relief assembly 900 is coupled to the enclosure 10. The sealing region 924 can surround the valve opening 911, such as in the example currently depicted. The sealing region 924 surrounds the valve airflow pathway 906. The coupling structure 920, including the sealing region(s) 924 can have configurations and alternate configurations that have been described above.

The valve body 930 is generally configured to accommodate pressure release from the enclosure. The valve body 930 is generally configured to accommodate pressure release from the first axial end 902 to the second axial end 904 through the frame 910. A valve body 930 is sealably disposed on a valve mounting surface 912 across the valve opening 911 such that the valve airflow pathway 906 is obstructed by the valve body 930. The valve body 930, the valve body 930 and the valve mounting surface 912 can be consistent with valve bodies described in detail above.

In the present example, the valve body 930 has a plurality of detents 940 that releasably secure the valve body 930 to the frame 910. The detents are configured to release the valve body 930 from the frame 910 upon a minimum pressure differential across the valve opening 911. The detents 940 are disposed around an outer perimetric surface, such as an outer circumferential surface, of the valve body 930. In the current example, the detents 940 can be consistent with valve bodies described in detail above.

When the pressure inside the enclosure spikes above a minimum pressure differential between inside the enclosure and the outside environment, the pressure inside the enclosure pushes against the enclosure side of the valve body 930, which deploys the detent 940 (similar to the discussion above) to decouple the valve body 930 from the valve mounting surface 912. The mechanism of deployment can be consistent with valve bodies described in detail above.

In some embodiments, the valve body 930 is generally configured to be clear of the valve airflow pathway 906 upon the minimum pressure differential across the valve opening 911. Such a configuration can be consistent with valve bodies described in detail above.

In the present example, the pressure relief assembly 900 has a guard 960. The guard 960 is generally configured to prevent the passages of materials from within the enclosure 10 from exiting the enclosure 10, particularly when the valve body 930 has been released from the frame 910. The guard 960 generally extends across the valve airflow pathway 906. The guard is generally configured to be fixed relative to the valve airflow pathway 906. In some embodiments, the guard 960 extends across the valve airflow pathway 906. In the present example, the guard 960 defines a plurality of openings 964 spaced laterally across the valve airflow pathway 906. The guard 960 may have any suitable number of openings 964, each of which may have any suitable opening shape. Samples of suitable axial cross-sectional shapes of the opening 964 include rectangles, circles, polygons, and irregular shapes. The openings 964 are generally sized to obstruct the passages of particles having a minimum size. In particular, each of the openings 964 has a cross-sectional area that is smaller or equal to the cross-sectional area of particles that the guard 960 is configured to obstruct.

In some other embodiments, the guard 960 does not define openings and instead is a breathable porous material. For example, the guard 960 can be constructed of a porous plastic material that is breathable. In some embodiments the guard 960 is a sintered metal. In some embodiments the guard 960 is constructed of a ceramic material. The guard 960 can have porosity and void volumes consistent with descriptions above relevant to the porosity and void volumes of the valve body.

The guard 960 is generally positioned towards the first axial end 902 of the assembly 900. In embodiments, the pressure relief assembly 900 may include more than one guard 960. In embodiments, the guard 960 may include multiple layers stacked in the axial direction, where each layer defines a plurality of openings. In one such example, the plurality of openings in one layer do not laterally align in the axial direction with the plurality of openings in the other layer to create a tortuous flow path through the first end 902 of the assembly 900.

The guard 960 is generally fixed relative to the valve opening, but the configuration of fixing the guard 960 relative to the valve opening is not particularly limited. In some embodiments, the guard 960 is fastened to the enclosure 10. In the current example, the guard 960 is fastened to the frame 910. The frame 910 and the guard 960 are fastened via a coupling feature 929. In the current example, the coupling feature 929 defines an interference fit. In the current example, the coupling feature 929 includes a plurality of coupling receptacles defined by the guard 960 that are each configured to frictionally engage a corresponding coupling protrusion 928 of the frame 910 to fasten the guard 960 to the frame 910. The coupling feature 929 may have any suitable number of coupling protrusion 928, each of which may have any suitable shape. Each coupling receptacle forms a mating shape that is configured to engage a corresponding structure defined by the guard 960. In some alternate embodiments, the frame 910 can define the coupling receptacles and the guard can define the coupling protrusions. In various embodiments, the coupling receptacles and coupling protrusions can be welded, such as through a heat weld, to further fix the guard 960 to the frame 910.

Other types of interference fits are also contemplated between the guard 960 and the frame 910. In some embodiments, the coupling feature 929 can form a snap-fit connection between the guard 960 and the frame 910. As another example, the coupling feature 929 can include a threaded fastener such as a screw that is configured to engage aligned fastener receptacles defined by the guard 960 and the frame 910. As another example, the coupling feature 929 can define a bayonet connection between the guard 960 and the frame 910. In some embodiments, the guard 960 can be coupled to the frame 910 with an adhesive, through a weld, or through other approaches.

In some embodiments one of the guard 960 and the enclosure 10 defines a coupling protrusion and the other of the guard 960 and the enclosure 10 defines a coupling receptacle that are configured to be coupled.

It should be noted that a guard is not limited to embodiments generally consistent with FIG. 14. A guard can be used with any of the pressure relief assemblies described herein.

### Exemplary Aspects of a Pressure Relief Assembly With a Rupture Valve

Aspect 1. A pressure relief assembly comprising:
a valve body comprising a porous plastic plug having sealing surface configured to form a seal around a valve opening, wherein the valve body has an unweakened region having a first thickness and a weakened region having a second thickness that is less than the first thickness, wherein the valve body has a threshold rupture pressure defined by the weakened region.

Aspect 2. The pressure relief assembly of any one of Aspects 1 and 3-19, further comprising a frame comprising:
a coupling structure configured to couple to an enclosure;
a valve mounting surface; and
a valve opening within the valve mounting surface, wherein the valve body is sealably disposed on the valve mounting surface across the valve opening.

Aspect 3. The pressure relief assembly of any one of Aspects 1-2 and 4-19, wherein the frame further comprises breathable porous plastic.

Aspect 4. The pressure relief assembly of any one of Aspects 1-3 and 5-19, wherein the valve body further comprises a coupling structure configured to couple to an enclosure.

Aspect 5. The pressure relief assembly of any one of Aspects 1-4 and 6-19, wherein the coupling structure comprises a threaded circumferential surface.

Aspect 6. The pressure relief assembly of any one of Aspects 1-5 and 7-19, wherein the coupling structure comprises a snap fit.

Aspect 7. The pressure relief assembly of any one of Aspects 1-6 and 8-19, wherein the coupling structure comprises a bayonet connector.

Aspect 8. The pressure relief assembly of any one of Aspects 1-7 and 9-19, wherein an enclosure is configured to be overmolded to the valve body.

Aspect 9. The pressure relief assembly of any one of Aspects 1-8 and 10-19, wherein the valve body has an oleophobic coating.

Aspect 10. The pressure relief assembly of any one of Aspects 1-9 and 11-19, wherein the valve body is configured to obstruct passage of liquid water.

Aspect 11. The pressure relief assembly of any one of Aspects 1-10 and 12-19, wherein the valve body has a mean pore size of 0.1 μm to 100 μm, 0.1 μm to 10 μm, or 1 μm to 50 μm.

Aspect 12. The pressure relief assembly of any one of Aspects 1-11 and 13-19, wherein the valve body has a maximum pore size of less than 350 μm, 200 μm, 100 μm, or 50 μm.

Aspect 13. The pressure relief assembly of any one of Aspects 1-12 and 14-19, wherein the valve body has a void volume between 30% to 50%.

Aspect 14. The pressure relief assembly of any one of Aspects 1-13 and 15-19, wherein the valve body comprises at least one polymer in the group consisting of: polytetrafluoroethylene, polysulfone, polyethylene, polyethylenimine, polypropylene and polyvinylidene difluoride.

Aspect 15. The pressure relief assembly of any one of Aspects 1-14 and 16-19, wherein the valve body comprises ceramic.

Aspect 16. The pressure relief assembly of any one of Aspects 1-15 and 17-19, wherein the valve body comprises an adsorbent.

Aspect 17. The pressure relief assembly of any one of Aspects 1-16 and 18-19, wherein the valve body defines a cavity and the adsorbent is disposed in the cavity.

Aspect 18. The pressure relief assembly of any one of Aspects 1-17 and 19, wherein the valve body comprises adsorbent particles.

Aspect 19. The pressure relief assembly of any one of Aspects 1-18, wherein the adsorbent particles comprise carbon particles.

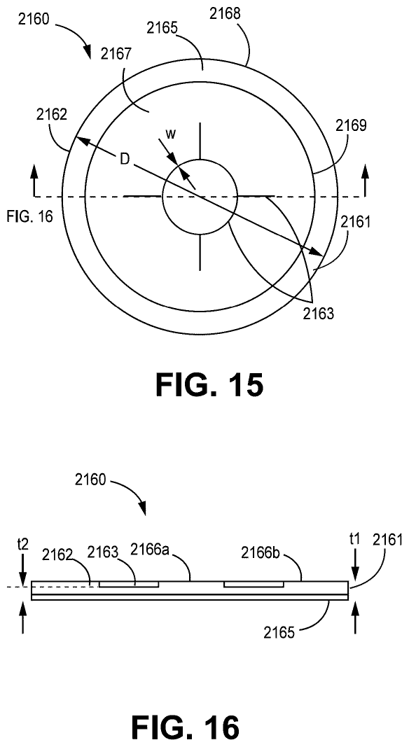

FIG. 15 is a facing view of an example valve assembly having a valve body 2160 consistent with various embodiments. FIG. 16 is an example cross-sectional view consistent with the valve assembly having a valve body 2160 depicted in FIG. 15. The valve body 2160 is generally configured to rupture at a particular threshold rupture pressure to allow for pressure equalization. The term “threshold rupture pressure” is the minimum pressure differential across the valve body 2160 that causes rupturing of the valve body 2160. The threshold rupture pressure can be specific to a particular temperature or temperature range. The valve body 2160 is generally a porous plastic plug.

A “porous plastic plug” is used herein to refer to a continuous self-supporting plastic component that is breathable and is configured to maintain its shape under the force of gravity. A porous plastic plug is distinguishable from, for example, a membrane or film that is not self-supporting under the force of gravity and requires a support structure to maintain its shape. “Continuous” is defined herein as forming an uninterrupted layer across its width and length that lacks openings (excluding pores).

In some embodiments, the valve body 2160 has a first thickness t1 ranging from 0.5 mils (12.7 μm) to 10 mils (254 μm). In some embodiments, the valve body 2160 has a first thickness t1 ranging from 1 mil (25.4 μm) to 5 mils (127 μm). In some particular embodiments, the valve body 2160 has a first thickness t1 ranging from 0.5 mil (12.7 μm) to 3 mil (76.2 μm). The valve body 2160 also defines a weakened region 2163 having a second thickness t2. The weakened region 2163 is a region where the thickness of the valve body 2160 is reduced. In various implementations, the weakened region 2163 defines the threshold rupture pressure of the valve body 2160. In various embodiments, the introduction of a weakened region 2163 advantageously lowers the threshold rupture pressure of the valve body 2160. The weakened region 2163 can have various configurations. Generally, the weakened region 2163 has a width w (see FIG. 15) of less than 300 μm. In some embodiments the weakened region 2163 has a width w of at least 1 μm. The weakened region 2163 can have a width w of less than 600 μm. In some embodiments, the weakened region 2163 has a width w from 20 μm to 50 μm. The weakened region 2163 can have a width w from 100 μm-200 μm, 125 μm-175 μm, or 450 μm-550 μm.

The thickness of the valve body 2160 in the weakened region 2163 (the weakened region having the second thickness t2) is generally less than the thickness of the valve body 2160 in the un-weakened regions (the un-weakened regions having the first thickness t1). In some embodiments the second thickness t2 is under 75% of the first thickness t1 of the valve body 2160 in the un-weakened regions. In some embodiments the second thickness t2 of the valve body 2160 is 50% or less than the first thickness t1 of the valve body 2160. In various embodiments, the weakened region 2163 is defined by areas where the porous plastic plug 2162 has been thinned. The porous plastic plug 2162 can be thinned through a variety of approaches such as lasing operations, etching, compression, kiss cutting, and the like.

The porous plastic plug 2162 can be constructed of a variety of different materials and combinations of materials. In a variety of implementations, it can be desirable to use a polymer that is resistant to corrosion in the intended operating environment of the valve body. In a variety of implementations, it is desirable to use a polymer to construct the porous plastic plug 2162 that has a high fatigue resistance and durability to prevent premature failure in response to environmental pressure differential cycles over the course of its useful life.

In some embodiments, the valve body 2160 is generally configured to obstruct passage of liquid water. In such embodiments, the pores defined by the valve body 2160 are sufficiently small to obstruct the passage of liquid water. In some embodiments, the pores defined by the valve body 2160 accommodate passage of water vapor, however. Various types of materials would be suitable for use as the valve body. The valve body can have a mean pore size of 0.1 μm to 100 μm, 0.1 μm to 10 μm, or 1 μm to 50 μm. In some embodiments, the valve body has a maximum pore size of less than 350 μm, 200 μm, 100 μm, or 50 μm. The valve body 2160 can have a void volume between 30% to 50% in various embodiments.

Generally, the valve body is a polymer such as: polytetrafluoroethylene, polysulfone, polyethylene, polyethylenimine, polypropylene and polyvinylidene difluoride, or the like. In some embodiments the valve body 2160 can include ceramic. In some embodiments the valve body 2160 can include sintered metal. In some embodiments, the valve body 2160 has an adsorbent such as adsorbent particles. The adsorbent particles can be any suitable material, such as carbon particles or the like. In some embodiments the valve body 2160 is partially constructed of carbon particles, and in some other embodiments the valve body 2160 defines a cavity and carbon particles are disposed within the cavity.

In various embodiments the polymer is resistant to liquid flow therethrough. In some embodiments, one or more functional coatings can be applied to the valve body 2160 or the porous plastic plug 2162. For example, an oleophobic coating can be applied to one or both sides of the valve body 2160 and/or the porous plastic plug 2162. In some embodiments a hydrophobic coating can be applied to one or both sides of the valve body 2160 and/or the porous plastic plug 2162.

In some embodiments the valve body 2160 can omit a support layer by virtue of the porous plastic plug 2162 being self-supporting.

In various embodiments, such as the one depicted, the weakened region 2163 defines two distinct areas 2166a, 2166b, meaning that the areas are separated from each other by the weakened region 2163, which is visible in FIG. 15. In this example, the weakened region 2163 defines a circle and a first area 2166a is within the circle, and a second area 2166b is outside the circle. The weakened region 2163 can define shapes alternate to or in addition to a circle such as polygonal shapes, ovals, and the like. In various embodiments, such as the one depicted, the weakened region 2163 separates portions of a single area. In the current example, the weakened region 2163 defines a plurality of radial extensions that each separate portions of the second polymeric area.

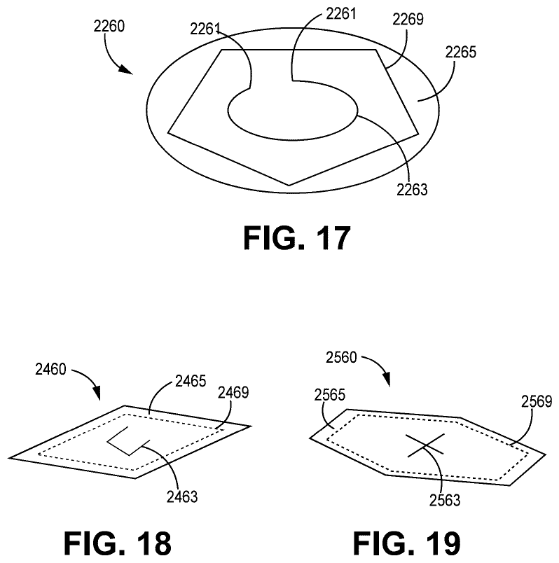

FIG. 17 is a perspective view of another example valve body 2260 consistent with embodiments. In the current example, the valve body 2260 has a weakened region 2263 that does not separate the valve body 2260 into discrete areas. Rather, the weakened region 2263 forms a circular flap having two discrete endpoints 2261. In this example the weakened region 2263 forms a portion of a circle rather than a complete circle. FIGS. 18 and 19 each depict a perspective view of alternate example valve bodies 2460, 2560 where the weakened regions 2463, 2563 have alternate shapes. In FIG. 18 the weakened region 2463 has three linear segments joined at corners to form three sides of a rectangular shape. FIG. 19 depicts a valve body 2560 having a weakened region 2563 that forms a cross shape, where two linear segments intersect at their midpoints. FIGS. 18 and 19 will be discussed in more detail below and will generally be consistent with the descriptions of FIGS. 15-17, except where differences are explicitly described or depicted. The weakened region can have other shapes, however, such as a polygonal shape or an ovular shape.

The facing surfaces of valve bodies consistent with the technology disclosed herein can have a variety of different shapes. In the examples of FIGS. 15 and 17, the valve bodies have a circular shape. In some embodiments the valve body can define an ovular shape. In the example of FIG. 18, the facing surfaces of the valve body 2460 has a rectangular shape. In the example of FIG. 19, the facing surfaces of the valve body 2560 has a hexagonal shape. In various embodiments where the valve body has a polygonal shape, the corners can be rounded corners.

Returning to the discussion of FIGS. 15 and 16, in various embodiments, the valve body 2160 has a coupling structure 2161 configured to couple to an enclosure. In some embodiments the coupling structure 2161 is configured to couple to a frame that has its own coupling structure configured to couple to an enclosure. For example, a surface of the valve body 2160 can be configured to be coupled to a housing about an opening. More particularly, a perimeter region 2165 of the valve body 2160 can define the coupling structure 2161, where the perimeter region 2165 is configured to be welded or otherwise adhered to a housing about an opening. In some examples, an adhesive defines the perimeter region 2165 on one side of the valve body 2160 that is configured to be coupled to the housing. In such embodiments, the central region 2167 of the valve body 2160 lacks the adhesive layer. In some other embodiments, the adhesive layer extends across the perimeter region 2165 and a central region 2167 of the valve body 2160. In some such embodiments, a protective layer is disposed over the adhesive layer located within the central region 2167 to obstruct the second adhesive layer. Prior to installation of the valve body to a housing, a removable liner can be coupled to the adhesive located in the perimeter region 2165, where the removable liner is configured to be removed from the second adhesive to allow adherence of the valve body 2160 to the housing. In some embodiments, the perimeter region 2165 lacks an adhesive layer. In such configurations the perimeter region 2165 of the valve body 2160 can be configured to be welded to an enclosure about an opening or an enclosure can be overmolded around the perimeter region 2165 of the valve body 2160.

In the current example, the perimeter region 2165 is defined between the outer perimeter 2168 of the valve body 2160 and an inner perimetric boundary 2169 spaced radially inward from the outer perimeter 2168. In various embodiments the inner perimetric boundary 2169 of the perimeter region 2165 has the same shape as the outer perimeter which is currently circular. In some other embodiments the inner perimetric boundary 2169 can have a different shape than the outer perimeter 2168. For example, the outer perimeter can be a circular shape, and the inner perimetric boundary can be a polygonal shape, such as depicted in FIG. 17 where the perimeter region 2265 has an inner perimetric boundary 2269 is pentagonal. In the example of FIG. 18, the perimeter region 2465 has an inner perimetric boundary 2469 that has a rectangular shape. In the example of FIG. 19, the perimeter region 2565 has an inner perimetric boundary 2569 that has a hexagonal shape. The shape of the inner perimetric boundary of the perimeter region may advantageously impact the threshold rupture pressure. For example, in some implementations, an inner perimetric boundary that is polygonal shaped may advantageously decrease the threshold rupture pressure. In some implementations, an inner perimetric boundary that has relatively sharp corners may advantageously decrease the threshold rupture pressure.

In some other embodiments, the coupling structure forms a mating structure that is configured to mate with a corresponding structure defined by the enclosure or a frame component. For example, in some embodiments the coupling structure 2161 includes a threaded circumferential surface. The threaded circumferential surface can be configured to frictionally receive mating threads of an enclosure or frame component. In some embodiments, the coupling structure 2161 includes a snap fit that frictionally engages an enclosure about an opening. As another example, the coupling structure can define a connector that interlocks with the enclosure about the enclosure opening, such as a bayonet connector that interlocks with a bayonet receptacle.

Returning again to FIGS. 15-16, in various embodiments, the valve body 2160 has an outer dimension D of less than 60 mm, where “outer dimension” is used to mean a maximum dimension across the valve body such as a diagonal (for example polygonal shapes such as in FIGS. 18 and 19) or a diameter. In some other embodiments the valve body 2160 has an outer dimension D of greater than 70 mm, however. In some embodiments, the valve body has an outer dimension D of less than 50 mm or even 45 mm. In some embodiments, the valve body has an outer dimension D between 20 mm and 40 mm. In some embodiments, the valve body has an outer dimension D between 7 mm and 15 mm. In some embodiments, the valve body has an outer dimension D between 25 mm and 35 mm. In one particular example, the valve body has an outer dimension D of about 32 mm. The outer dimension D of the valve body can be equal to the corresponding outer dimension of each of the porous plastic plug 2162 and the support layer.

Generally, as the outer dimension of the valve body 2160 decreases, the burst pressure increases (absent weakened regions). However, despite the relatively small size of valve bodies disclosed herein, such valve bodies have a relatively low threshold rupture pressure, which can be advantageous in various implementations. In some embodiments the valve body has a threshold rupture pressure of less than 10 psi, less than 7 psi, or less than 6 psi. The threshold rupture pressure can be between 4 psi and 6 psi. The threshold rupture pressure of the valve body be greater than 2 psi, 3 psi, or 4 psi. The threshold rupture pressure can be at room temperature (25° C.).

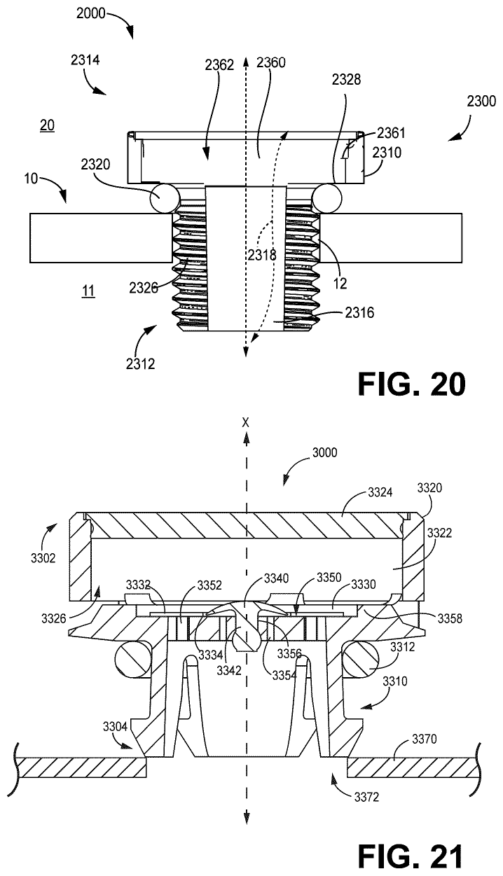

FIG. 20 depicts a cross-sectional view of an example pressure relief assembly 2000 consistent with the technology disclosed herein, where the pressure relief assembly is installed in an enclosure 10. The valve body system 2300 is generally configured to allow rapid airflow out of the enclosure 10 upon a threshold rupture pressure between the interior 11 of the enclosure 10 and the outside environment 20. The pressure relief assembly 2000 has a frame 2310 and a valve body 2360. The frame 2310 defines a central axis x.

The frame 2310 is generally configured to position the valve body 2360 on the enclosure 10. The frame 2310 generally has a first axial end 2312 and a second axial end 2314. The first axial end 2312 defines an axial opening 2316. The axial opening 2316 is generally configured to be in open communication with the interior 11 of the enclosure 10. The frame 2310 has an airflow pathway 2318 that generally extends from the first axial end 2312 towards the second axial end 2314. A sealing surface 2320 is defined about the airflow pathway 2318 between the first axial end 2312 and the second axial end 2314. The sealing surface 2320 is configured to form a seal with the enclosure 10 to prevent the ingress or egress of substances relative to the enclosure 10. The sealing surface 2320 can be an axial or radial seal that is configured to seal against the housing 10 about a housing opening 12 defined in the housing 10. In some embodiments, the sealing surface 2320 faces towards the first axial end 2312 to form an axial seal with the enclosure 10. In some embodiments, the sealing surface 2320 faces radially outward and is configured to form a radial seal with the enclosure 10.

The frame 2310 defines a valve opening and a valve mounting surface around the valve opening, where the valve opening defines a portion of the airflow pathway 2318. A valve body 2360, such as a valve body consistent with the descriptions above, is coupled to the frame 2310 on the valve mounting surface across the airflow pathway 2318. The valve body 2360 obstructs the airflow pathway 2318 such that the first axial end 2312 of the frame 2310 is separated from the second axial end 2314 of the frame 2310 (until the valve body 2360 ruptures). The valve body 2360 has a porous plastic plug that can be consistent with the discussions above.

The valve body 2360 is generally coupled to a mounting surface 2328 defined by the frame 2310. The mounting surface 2328 is generally planar and extends around the airflow pathway 2318. The mounting surface 2328 defines an opening 2362 that is a portion of the airflow pathway 2318. The opening in the mounting surface 2328 can have an outer dimension d (such as a diagonal or a diameter) that corresponds to the size of the valve body 2360. The outer dimension d of the opening in the mounting surface 2328 is generally less than a corresponding outer dimension D of the valve body 2360. The outer dimension d of the opening in the mounting surface 2328 can be between 60% and 95% of the outer dimension D of the valve body 2360. In some embodiments the outer dimension d of the opening ranges from 1 mm to 56 mm. In some embodiments the outer dimension d of the opening ranges from 20 mm to 40 mm. In some embodiments the outer dimension d ranges from 15 mm to 35 mm. In some embodiments the outer dimension d of the opening is at least 3 mm. In some embodiments the outer dimension d of the opening is less than 15 mm, 10 mm, or 7 mm.

In various embodiments the valve body 2360 is coupled to the mounting surface 2328 of the frame 2310 through a variety of approaches known in the art. A perimeter region 2361 of valve body 2360 is coupled to the frame 2310 in a region surrounding the airflow pathway 2318. The valve body 2360 and the frame 2310 form an airtight seal about the airflow pathway 2318. In various embodiments, the valve body 2360 and the frame 2310 form a seal that resists impingement by liquids such as water. The valve body 2360 can be coupled to the frame 2310 through the use of an adhesive, welding (heat or ultrasonic welding, as examples), over-molding, or through other approaches known in the art. In some embodiments where an adhesive is employed, the adhesive is a pressure-sensitive adhesive, such as a pressure sensitive adhesive tape. In some embodiments the adhesive is a double-sided adhesive tape. One such example is an acrylic-based pressure sensitive adhesive. Another such example is a silicone-based pressure sensitive adhesive. In some embodiments the adhesive is a curable adhesive material such as silicone-based adhesive. In some embodiments the porous plastic plug (162, FIG. 16) of the valve body 2360 is configured to be welded to the frame 2310 across the airflow pathway 2318.

In the current example, the first axial end 2312 of the frame 2310 defines an enclosure coupling structure 2326 about the airflow pathway 2318. The coupling structure 2326 is generally configured to couple to the enclosure 10 about the enclosure opening 12. The coupling structure 2326 is generally configured to bring the sealing surface 2320 into sealing engagement with the enclosure 10 about the enclosure opening 12. In the current example, the coupling structure 2326 is a threaded surface configured to frictionally engage a mating threaded surface of the enclosure 10 about the enclosure opening 12. In some other embodiments, a fastening structure such as bolts, screws, or the like can be used to couple the frame 2310 to the enclosure 10. In some embodiments, the fastening structure is a bayonet connector that is configured to be received by a mating connector defined by the enclosure. In such examples, the fastening structure can be configured to be mutually received by fastener openings defined by the frame 2310 and aligned fastening openings of the enclosure 10. In such examples, sealing surfaces can be defined between the fastening structures and the airflow pathway 2318, such as around the fastening structures.

In various embodiments, the valve body system 2300 is configured to meet IP67 waterproofness standards when coupled to an enclosure 10 in accordance with the International Electrotechnical Commission (IEC) standard 60529.

Various approaches can be used to construct valve body systems consistent with the technology disclosed herein. In various embodiments a weakened region is formed in the porous plastic plug. The valve body is sealably coupled to a housing.

The porous plastic plug is generally consistent with corresponding components discussed above. The weakened region generally extends through a portion of the thickness of the porous plastic plug and has a width of less than 300 μm consistent with discussions above. In various embodiments the weakened region is formed through a lasing operation on the porous plastic plug. In various embodiments the laser is relatively low powered. In various embodiments the laser has a power output of less than or equal to 45 watts.

The valve body is sealably coupled to a frame across an airflow pathway defined by the frame. The valve body can be sealably coupled to the frame via adhesive, heat welding, or the like, as has been described above. Also, as has been described above, the frame generally has a sealing surface that is configured to surround the airflow pathway, where the sealing surface is configured to form a seal between the frame and enclosure about the airflow pathway. The frame can be coupled to an enclosure via fastening structures that have been described in detail above.

### Exemplary Aspects of a Pressure Relief Assembly With a Vent in Parallel With a Valve

Aspect 1. A pressure relief assembly comprising: a housing defining a cavity, a first end, a second end, a vent opening, a valve opening, and a coupling structure configured to couple to an enclosure; a passive airflow vent disposed in the housing across the vent opening, wherein the passive airflow vent is a porous plastic plug, wherein the housing defines a housing opening between an ambient environment and the passive airflow vent; and a one-way relief valve disposed in the housing and forming a seal over the valve opening, wherein the one-way relief valve is arranged in parallel with the passive airflow vent with respect to airflow through the housing.

Aspect 2. The pressure relief assembly of any one of Aspects 1 and 3-15, wherein the valve opening comprises a plurality of openings defining a segmented annulus about the central axis.

Aspect 3. The pressure relief assembly of any one of Aspects 1-2 and 4-15, wherein the fluid flow pathway defines a tortuous path between the housing opening and the one-way relief valve.

Aspect 4. The pressure relief assembly of any one of Aspects 1-3 and 5-15, further comprising an cap coupled to the housing towards the first end.

Aspect 5. The pressure relief assembly of any one of Aspects 1-4 and 6-15, wherein the cap defines the first end of the housing and the cap extends across the one-way relief valve and the passive airflow vent.

Aspect 6. The pressure relief assembly of any one of Aspects 1-5 and 7-15, the housing comprising a first obstruction, wherein the first obstruction is positioned between the housing opening and the passive airflow vent.

Aspect 7. The pressure relief assembly of any one of Aspects 1-6 and 8-15, the housing comprising a second obstruction extending into the fluid flow pathway, wherein the second obstruction is positioned between the housing opening and the one-way relief valve.

Aspect 8. The pressure relief assembly of any one of Aspects 1-7 and 9-15, the coupling structure defining a fluid flow pathway between an outside of the housing and the passive airflow vent.

Aspect 9. The pressure relief assembly of any one of Aspects 1-8 and 10-15, wherein the housing defines a first fluid flow pathway between an outside of the housing and the passive airflow vent, the coupling structure defines a second fluid flow pathway between the outside of the housing and the passive airflow vent, and the one-way relief valve is configured to unseal when the pressure in the second fluid flow pathway is greater than the pressure in the first fluid flow pathway by 0.5 to 1 psi.

Aspect 10. The pressure relief assembly of any one of Aspects 1-9 and 11-15, wherein the housing further defines a mounting surface that defines the vent opening.

Aspect 11. The pressure relief assembly of any one of Aspects 1-10 and 12-15, wherein the vent opening is a plurality of openings defining a segmented annulus about the central axis.

Aspect 12. The pressure relief assembly of any one of Aspects 1-11 and 13-15, wherein the one-way relief valve is an umbrella valve.

Aspect 13. The pressure relief assembly of any one of Aspects 1-12 and 14-15, wherein the housing defines radial openings about the central axis, wherein the radial openings define a fluid flow pathway between an outside of the housing and the passive airflow vent.

Aspect 14. The pressure relief assembly of any one of Aspects 1-13 and 15, wherein the passive airflow vent and the one-way relief valve are concentric.

Aspect 15. The pressure relief assembly of any one of Aspects 1-14, further comprising a seal abutting the coupling structure.

FIG. 21 is a perspective cross-sectional view of yet another example pressure relief assembly 3000 consistent with the technology disclosed herein. Similar to assemblies previously described, the current assembly 3000 is generally configured to allow gases to pass between an enclosure 3370 and the environment through a passive airflow vent 3330 under normal pressure conditions. Upon a high-pressure event inside the enclosure 3370, however, the assembly 3000 is configured to allow gases to escape the enclosure 3370 by bypassing the passive airflow vent 3330. The assembly 3000 generally has a vent housing 3320, a coupling structure 3310, a passive airflow vent 3330, and a relief valve 3340. The passive airflow vent 3330 is a porous plug, which has been described in detail above elsewhere herein, the discussions of which are incorporated by reference here.

The vent housing 3320 is generally configured to house the passive airflow vent 3330 and the relief valve 3340. The vent housing 3320 defines a cavity 3322, a first end 3302, a second end 3304, and a coupling structure 3310. The vent housing 3320 can be constructed of a variety of materials and combinations of materials. In some embodiments the vent housing 3320 is constructed of plastic or metal. In examples, at least a portion of the vent housing 3320 is an injection-molded plastic. In examples, at least a portion of the vent housing 3320 is a porous plastic material. In some embodiments the vent assembly has a cap 3324 is coupled to the vent housing 3320 towards the first end 3302. The cap 3324 can form a unitary component with the vent housing 3320 in some other embodiments. The cavity 3322 is also defined by the cap 3324.

The valve body is generally configured to receive the passive airflow vent 3330 and the relief valve 3340. The passive airflow vent 3330 is coupled to the housing across the vent opening 3352. The passive airflow vent 3330 is generally configured to allow passive airflow between the enclosure 3370 and the ambient environment while preventing liquids and particulates from entering into the enclosure 3370. The passive airflow vent 3330 is positioned in fluid communication with the opening 3372 in the enclosure 3370. The passive airflow vent 3330 can be coupled to the housing with an adhesive. The passive airflow vent 3330 can be constructed of materials similar to vents described herein above. In the current example, the passive airflow vent 3330 forms an annulus, and the passive airflow vent 3330 can be coupled to the mounting surface 3350 with adhesive disposed adjacent to its outer perimeter 3332 and its inner perimeter 3334 to form a seal between the passive airflow vent 3330 and the mounting surface 3350.

The valve 3340 is sealably disposed on the mounting surface 3350 across the valve opening 3354. In a variety of embodiments, the valve 3340 is an umbrella valve. The valve 3340 is generally configured to form a seal around the valve opening 3354 to allow gases to passively vent through the vent opening 3352 and passive airflow vent 3330 under normal pressure conditions and, upon a pressure spike within the enclosure 3370 above a threshold T, the pressure displaces the umbrella valve 3340 to unseal from the valve opening 3354 and allow gas to bypass the passive airflow vent 3330 and exit the enclosure 3370 through the valve opening 3354. The valve 3340 is configured in parallel with the passive airflow vent 3330 with respect to airflow between the ambient environment and the enclosure 3370.

The relief valve 3340 is generally formed of an elastomeric material. The relief valve 3340 can also be other types of relief valves, but will generally be a one-way relief valve. The relief valve 3340 can be any type of umbrella valve, such as a Belleville valve. In some embodiments the relief valve 3340 is configured to reseal around the valve openings 3354 when the pressure inside the enclosure 3370 returns to a level at or below the pressure threshold T.

The coupling structure 3310 is generally configured to couple the assembly 3000 to an enclosure 3370 about an opening 3372 defined by the enclosure 3370. The coupling structure 3310 is defined towards the second end 3304 of the vent housing 3320. The coupling structure 3310 is generally configured to engage the enclosure 3370. In the current example, the coupling structure 3310 forms a snap-fit connection with the enclosure 3370. In some other embodiments, the coupling structure 3310 forms a mating structure that is configured to mate with a corresponding structure defined by the enclosure 3370. For example, the coupling structure 3310 can define a screw thread configured to be received by the enclosure 3370 about the opening 3372. As another example, the coupling structure 3310 can define a connector that interlocks with the enclosure 3370 about the opening 3372, such as a bayonet connector. In some embodiments, the coupling structure 3310 can be coupled to the enclosure 3370 about the opening 3372 with an adhesive. The coupling structure can be consistent with other coupling structures described in detail elsewhere herein.

In embodiments consistent with the current example, a seal 3312 generally abuts the coupling structure 3310. The seal 3312 is configured to create a seal between the assembly 3000 and the enclosure 3370 when the assembly 3000 is coupled to the enclosure 3370. The seal 3312 can be an elastomeric material. In some embodiments the seal 3312 is rubber or another gasketing or sealing material.

In examples consistent with the current embodiment, the vent housing 3320 defines an opening 3326 between the ambient environment and the cavity 3322 to define a first fluid flow pathway between the outside of the vent housing 3320 and the mounting surface 3350 and/or the passive airflow vent 3330. Also, the coupling structure 3310 defines a second fluid flow pathway between the outside of the vent housing 3320 and the passive airflow vent 3330. In such embodiments, the umbrella valve 3340 is configured to unseal from the mounting surface 3350 when the pressure in the second fluid flow pathway is greater than the pressure in the first fluid flow pathway by at least 0.2 psi and no more than 3 psi and, in some embodiments, from 0.5 psi to 1 psi.

The vent housing 3320 has an obstruction 3358 positioned between the opening 3326 and the passive airflow vent 3330. The obstruction 3358 creates a tortuous path between the opening 3326 and the passive airflow vent 3330, meaning that fluid flowing into the opening 3326 cannot directly impact the passive airflow vent 3330. Similarly, the obstruction 3358 is positioned between the opening 3326 and the valve 3340.

In examples consistent with the current embodiment, the passive airflow vent 3330 and the valve 3340 are concentric. While the valve 3340 is central to the passive airflow vent 3330, in some other embodiments the vent can be central to the valve. In examples consistent with the current embodiment, the vent housing 3320 defines a central axis X extending from the first end 3302 to the second end 3304. The mounting surface 3350 is about the central axis x. Although not completely visible in the current views, the valve opening 3354 is a plurality of openings defining a segmented annulus about the central axis X. Similarly, the vent opening 3352 is a plurality of openings defining a segmented annulus about the central axis X. Furthermore, the mounting surface defines a central opening 3356 about the central axis X and the umbrella valve 3340 has an extension portion 3342 that extends through the central opening 3356. The opening 3326 defined by the vent housing 3320 are a series of radial openings about the central axis X.

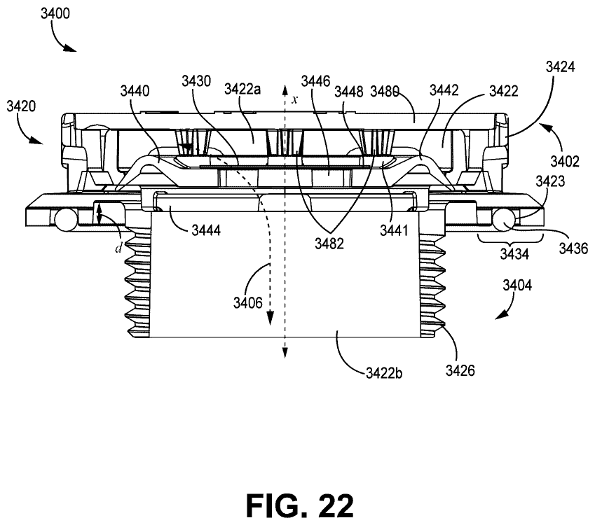

FIG. 22 is a cross-sectional view of another example pressure relief assembly consistent with the technology disclosed herein. The vent assembly 3400 is configured to allow for passive venting between an enclosure and an outside environment. The passive airflow vent 3430 is a porous plug, which has been described in detail above elsewhere herein, the discussions of which are incorporated by reference here.

The pressure relief assembly 3420 is configured to be coupled to an enclosure. The pressure relief assembly 3420 defines a vent cavity 3422 having an enclosure side 3422b and an ambient side 3422a. The pressure relief assembly 3420 has a passive airflow vent 3430 disposed in the vent cavity. The passive airflow vent 3430 extends across the vent cavity 3422. The enclosure side 3422b and the ambient side 3422a are in fluid communication through the passive airflow vent 3430. The pressure relief assembly 3420 defines a first axial end 3402 and a second axial end 3404. An airflow pathway 3406 extends through the vent cavity and the passive airflow vent 3430.

The pressure relief assembly 3420 defines circumferential threads 3426 positioned towards the second axial end 3404. The circumferential threads 3426 are configured to releasably engage the mating threads of an enclosure or an intermediary component that couples to an enclosure. The pressure relief assembly 3420 has a sealing surface 3434 that is configured to form a seal with the enclosure about an opening. The sealing surface 3434 faces the second axial end 3404 of the pressure relief assembly 3420. The sealing surface 3434 can include a seal 3436 disposed in a seal receptacle 3423, for example.

The pressure relief assembly 3420 and passive airflow vent 3430 can be consistent with descriptions already provided herein with respect to the porous plug. In the current implementation, the passive airflow vent 3430 has a disk shape. The passive airflow vent 3430 is disposed across an opening 3446. The passive airflow vent 3430 is disposed between the enclosure side 3422b of the cavity and the ambient side 3422a of the cavity.

A relief valve 3440 is disposed across an opening 3444 defined by the pressure relief assembly 3420. The relief valve 3440 is configured to be biased in a closed position during normal operating conditions. Upon a pressure spike within the enclosure side 3422b of the cavity beyond a threshold, the relief valve 3440 is configured to open to allow the release of air into the ambient side 3422a of the cavity, which extends to the environment outside of the enclosure. In various embodiments, upon the pressure within the enclosure side 3422b of the cavity returning to a level below the threshold, the relief valve 3440 closes again to resume normal operating conditions with passive airflow through the passive airflow vent 3430. In the current example, the relief valve 3440 is an elastomeric valve. More particularly, the relief valve 3440 is an umbrella valve, but other types of biased valves can also be used such as a duckbill valve, for example.

In the current example, the relief valve 3440 and the passive airflow vent 3430 collectively extend across the valve body opening 3444. The relief valve 3440 is mounted directly to the housing. The relief valve 3440 defines a vent opening(s) 3446 and a vent mounting surface 3448 about each vent opening 3446. The passive airflow vent 3430 is coupled to each vent mounting surface 3448 across each vent opening 3446. In various embodiments, the relief valve 3440 is configured to protect the passive airflow vent 3430 against impact by foreign materials, such as water or debris. In the current example, the vent mounting surface 3448 of the relief valve 3440 is surrounded by an outer portion 3442 of the relief valve 3440. Here, the outer portion 3442 of the relief valve 3440 is an elastomeric lip of the umbrella valve 3440. In the current example, the vent mounting surface 3448, and therefore the passive airflow vent 3430, is recessed in the axial direction relative to the outer portion 3442 of the relief valve 3440. As such, the outer portion 3442 of the relief valve 3440 is positioned radially between the passive airflow vent 3430 and perimetric environmental openings 3424 defined by the pressure relief assembly 3420. Also, the outer portion 3442 of the relief valve 3440 extends axially at least from the vent mounting surface 3448 towards the first end 3402 of the pressure relief assembly 3420, beyond the thickness of the passive airflow vent 3430.

In some other examples, a vent mounting surface can be defined by the housing rather than by the relief valve, and the relief valve can define a central opening that surrounds and exposes the vent mounting surface such that the vent can be coupled directly to the vent assembly within the opening of the relief valve.

Returning to the current figure, the relief valve 3440 has a plurality of engagement features 3441 that are configured to be engaged by corresponding mating features 3482 of the vent cover 3480. In some embodiments, each mating feature 3482 frictionally engages a corresponding engagement feature 3441. In some embodiments, when the vent cover 3480 is coupled to the rest of the pressure relief assembly 3420, the mating features 3482 and the pressure relief assembly 3420 compressibly engage the relief valve 3440. In the current example, the engagement features 3441 are sockets defined by the relief valve 3440 and the mating features 3482 are protrusions that are inserted into and frictionally engage the sockets. Other configurations are possible, however.

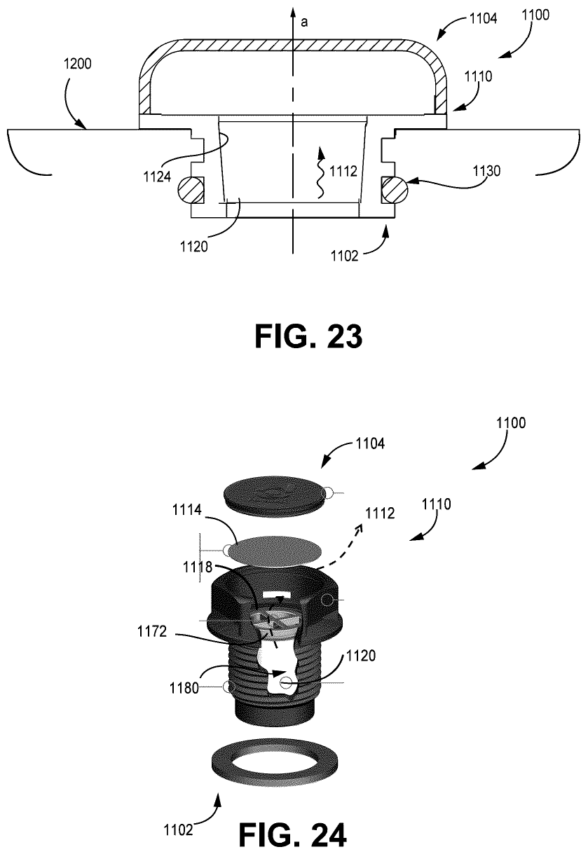

FIG. 23 is a cross-sectional view of a vent assembly 1100 consistent with the technology disclosed herein. The vent assembly 1100 generally has a vent housing 1110 and a porous plug 1120. The phrase “porous plug” is defined herein as a breathable component that is self-supporting, where the term “self-supporting” is used to mean that the porous plug maintains its shape under the force of gravity.

The vent housing has a first end 1102 and a second end 1104. The vent housing defines a mounting structure 1130 and an airflow pathway 1112 extending from the mounting structure 1130 to the environment external to the vent housing 1110. The porous plug 1120 is coupled to the vent housing 1110 and disposed across the airflow pathway 1112. The porous plug 1120 is positioned between the first end 1102 and the second end 1104 of the vent housing 1110.

The vent housing 1110 is generally configured to be coupled to an enclosure 1200. The enclosure 1200 is generally configured to contain system components. In some implementations the enclosure can be configured to contain a fluid. The enclosure 1200 can be used for a variety of applications such as, for example, transmission systems, batteries, transfer cases, gear boxes, power transfer units, axle components, and the like. Such applications can particularly be found within industries such as automotive, manufacturing, energy production, and the like. Those having skill in the art will appreciate the wide applicability of the current technology to a variety of technological fields. In some embodiments, the enclosure is not a hub cap.

The mounting structure 1130 is generally configured to couple the vent assembly 1100 to the enclosure 1200. The mounting structure 1130 can have a variety of configurations and combinations of configurations to facilitate coupling to the enclosure. The mounting structure 1130 can define a snap fitting, threaded screw, bayonet connector, butt connection, and key and lock connectors, that are configured to couple to the enclosure 1200. In many implementations the mounting structure 1130 includes an o-ring configured to sealably couple the vent assembly 1100 to the enclosure 1200 around a vent opening defined by the enclosure. In some embodiments, a mounting structure of a vent assembly can be configured to directly receive an opening defined in an enclosure.

The vent assembly 1100 is generally configured to vent the enclosure 1200 to which it is mounted while preventing the entry of dust, fluids, and other contaminants to the enclosure 1200. In embodiments, the vent assembly 1100 is designed to achieve IP69K ingress protection, meaning that, upon installation, the vent assembly 1100 protects the enclosure 1200 against close-range, high-pressure, high-temperature spray-downs. In some implementations where the vent assembly 1100 is used for venting an enclosure containing hydrocarbon fluid, the vent assembly 1100 can also be configured to enable the coalescence of oil droplets and drain the coalesced oil back into the enclosure 1200.

The porous plug can have a variety of configurations consistent with the technology disclosed herein. The porous plug 1120 is configured to facilitate passive airflow along the airflow pathway. In some embodiments, the porous plug 1120 is configured to obstruct the passage of debris along the airflow pathway, where debris can include water, particles, oil, and the like. In some embodiments, the porous plug 1120 is configured to obstruct the passage of oil. The porous plug 1120 can have a variety of different porosities depending on the desired function of the porous plug 1120. In some embodiments, the porous plug 1120 has a mean pore size of 0.1 μm to 100 μm, 0.1 μm to 10 μm, or 1 μm to 50 μm. In a variety of embodiments, the porous plug 1120 has a maximum pore size of less than 350 μm, 200 μm, 100 μm, or 50 μm. The porous plug can have a variety of void volumes. In some embodiments, the porous plug has a void volume between 30% to 50%. In a variety of embodiments, the vent body has a pore size range that changes from a first axial end of the porous plug to a second axial end of the porous plug. In some embodiments, the maximum and/or mean pore size of the porous plug towards the second axial end of the vent assembly 1100 is smaller than the maximum and/or mean pore size of the porous plug towards the first axial end of the vent assembly. Such a configuration may advantageously obstruct contaminants from entering the enclosure from the outside environment through the porous plug while facilitating coalescing and draining by the porous plug towards the interior of the enclosure, as an example.

Various types of materials would be suitable for use as the porous plug. Generally, the porous plug can be constructed of a polymer such as polytetrafluoroethylene, polysulfone, polyethylene, polyethylenimine, polypropylene, polyvinylidene difluoride, and combinations thereof. In a number of embodiments, the porous plug is constructed of ceramic. In some embodiments, the porous plug is constructed of an adsorbent such as adsorbent particles includes, for example, activated alumina, silica gel, activated carbon, molecular sieve carbon, molecular sieve zeolites and polymeric adsorbent. In some embodiments, the porous plug is constructed of sintered metal. It will be appreciated that various combinations of polymers, metals, adsorbents, and ceramics can be used to construct the porous plug.

In some embodiments, the porous plug defines a cavity that contains an adsorbent. Such a configuration may advantageously accommodate vapor adsorption in combination with venting functionality.

The porous plug generally has a thickness in the range of 0.02-4.0 inches or 0.03-2.0 inches. The thickness of the porous plug can be based on the breathability/porosity required by the particular implementation of the vent assembly and other functions of the porous plug. In some embodiments, the porous plug can have a thickness ranging from 0.02 inches to 0.5 inches, 3.0 to 4.0 inches, 0.5 to 1.5 inches, or alternate ranges.

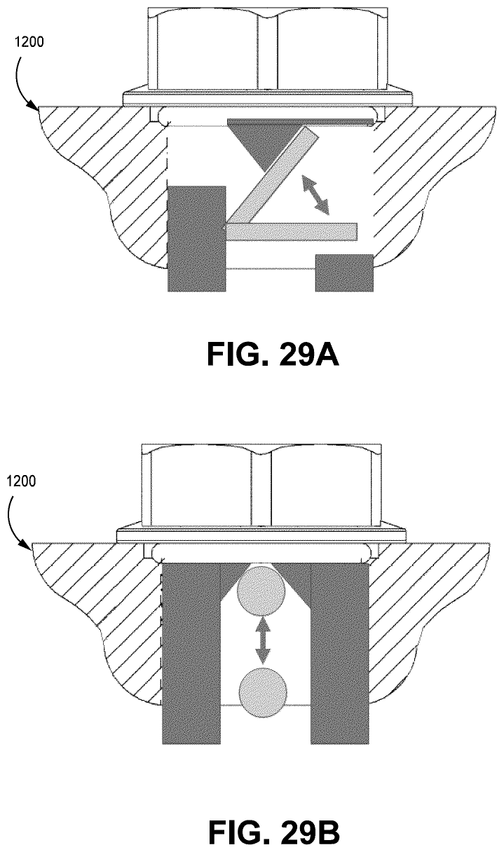

In some embodiments, the porous plug defines a check valve to selectively obstruct the airflow pathway. The check valve is generally configured to prevent liquid from entering the vent assembly from the enclosure as a result of, for example, splashing liquid. FIG. 29A and FIG. 29B shows example embodiments demonstrating a check valve consistent with the technology disclosed herein. In some embodiments, as shown in FIG. 29A, the check valve is a ball valve. In some other embodiments, as shown in FIG. 29B, the check valve is a flapper valve. Because the check valve is formed by the porous plug, when it is closed due to sprayed or splashed liquid from the enclosure, it still allows airflow.

In some embodiments, the porous plug has an oleophobic coating. Various types of methods would be suitable for use as the oleophobic coating. Modification of the surface characteristics of the porous plug, such as to increase the contact angle between the surface and the oil, such as with an oleophobic treatment, can enhance drainage capability of the porous plug and prevent the sorption of oil. Oleophobicity can be imparted to the porous plug by depositing a layer of oleophobic fluorochemical on the media fibers and/or by submerging the coalescing filter media in a solution of the fluorochemical (dip coating), among other means. Lick rolling, gravure coating, and/or curtain coating are some other example ways that the porous plug can be treated for oleophobicity.

The porous plug 1120 is coupled to the vent housing 1110. The porous plug 1120 can be coupled to the vent housing in a variety of ways, as will be appreciated. In a variety of embodiments, the porous plug 1120 and the vent housing 1110 are configured to mutually engage. In some embodiments, the porous plug 1120 and the vent housing 1110 mutually define a frictional fit that substantially retains the position of the porous plug 1120 relative to the vent assembly 1100. In a variety of embodiments, the porous plug 1120 and the vent housing 1110 define mating threads that are configured to mutually engage. Returning to FIG. 23, in some embodiments, the porous plug 1120 defines a taper 1124 in an axial direction. FIG. 23 shows an example embodiment demonstrating a perspective view of the porous plug 1120 that defines a taper 1124 consistent with the technology disclosed herein. In such embodiments, the porous plug 1120 and the vent housing 1110 are configured to mutually engage by the taper 1124 that facilitates an interference fit between the porous plug 1120 and the vent housing 1110. In some embodiments, the airflow pathway defined by the vent housing 1110 defines a taper. Such a taper can likewise facilitate an interference fit between the vent housing and the porous plug. In some embodiments, the porous plug is coupled to the vent housing by a weld, such as a thermal weld or ultrasonic weld. In some other embodiments, the porous plug is coupled to the vent housing by an adhesive, a glue, a tape, or the like.

In a variety of embodiments, the porous plug is a first porous plug, and the vent assembly has a second porous plug disposed across the airflow pathway. In such embodiments, the second porous plug has a different porosity than the first porous plug and the first porous plug. In at least one embodiment, the second porous plug is arranged in series along the airflow pathway. Similar to the discussions above relevant to a single porous plug having a porosity that transitions between the first and second end of the vent assembly, using a first porous plug can have a different maximum and/or mean porosity than the second porous plug to facilitation desired performance based on the position of the porous plug relative to the outside environment and/or inside the enclosure.

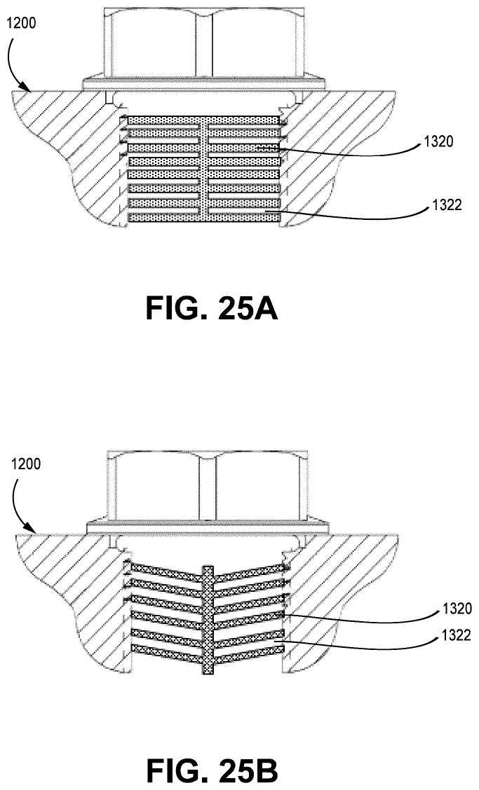

In a number of embodiments, the porous plug defines a plurality of laterally extending layers arranged in an axial direction. In such embodiments, there is at least one cavity between the layers. In some embodiments, as shown in FIG. 25A and 25B, the porous plug 1320 defines a plurality of cavities 1322. The cavities may advantageously capture liquid, such as oil or water, and facilitate coalescence and draining of the liquid towards the enclosure. In such embodiments, the porous plug defines a draining pathway through the first end 1102 of the vent assembly 1100. The draining pathway is generally configured to coalesce and drain oil particles from the air as it passes through the vent assembly via the airflow pathway from the enclosure.

In embodiments where a plurality of laterally extending layers is arranged in an axial direction, it can be desirable to have at least one of the laterally extending layers define an incline in the axial direction. Such a configuration may advantageously facilitate gravity assisted draining of the cavity. FIG. 25B shows an example embodiment demonstrating the laterally extending layers of the porous plug defining an incline in the axial direction consistent with the technology disclosed herein. Generally, in such embodiments, the plurality of laterally extending layers arranged in an axial direction in the vent housing allows gravity-assisted drainage of coalesced liquid.

In a variety of embodiments, the vent assembly can additionally have a passive airflow vent 1114 disposed in the vent housing across the airflow pathway. Such an example is depicted in FIG. 24. The passive airflow vent 1114 is generally configured to serve as a barrier to outside fluid and dust contamination for the enclosure while allowing air exchange between the enclosure and the environment external to the enclosure (such as the atmosphere). The passive airflow vent 1114 is generally disposed across the airflow pathway 1112. In a variety of embodiments, the passive airflow vent 1114 is coupled to a vent receiving surface 1118 defined by the vent housing 1110, where the vent receiving surface 1118 is also visible in FIG. 24.

In a number of embodiments, the passive airflow vent 1114 is the porous plug. The porous plug in such embodiments is consistent with the descriptions of porous plugs disclosed elsewhere herein. In some such examples, the porous plug can have a porosity that obstructs the passage of liquid water and is breathable. In some embodiments, the porous plug can be domed to increase the surface area available for airflow compared to a planar porous plug.

In other embodiments, the passive airflow vent 1114 is a breathable membrane. The breathable membrane can be an expanded polytetrafluoroethylene in various embodiments, although other types of breathable membranes are contemplated. In some embodiments, the membrane is pleated to increase airflow.

In a number of embodiments, the passive airflow vent 1114 is oleophobic. The passive airflow vent can have an oleophobic treatment. In one particular embodiment, the passive airflow vent has an oleophobicity rating of 6, 7 or 8 based on AATCC Specification 118-1992. In some other embodiments, the passive airflow vent is oleophilic.

It is noted that various embodiments of the technology disclosed herein can incorporate a passive airflow vent including examples depicted in the figures that do not necessarily have a passive airflow vent specifically visible, such as FIGS. 23, 25A-29B.

In some embodiments, the vent assembly defines a coalescing region 1180 within the airflow pathway between the mounting structure and the passive airflow vent, such as depicted in FIG. 24, although it is noted that various embodiments of the technology disclosed herein can incorporate a coalescing region including examples depicted in the figures that do not necessarily have a coalescing region specifically visible, such as FIGS. 23, 25A-29B.

The coalescing region 1180 is generally configured to coalesce and drain liquid particles from the air as it passes through the vent assembly 1100 via the airflow pathway 1412 from the enclosure 1200. Such a configuration prevents a high percentage of air-bound liquid particles from the enclosure 1200 from depositing on the passive airflow vent 1114, which can result in pore blockages in the passive airflow vent 1114, resulting in reduced vent life. The coalescing region 1180 is configured to enable coalescence of the liquid particles into droplets within the vent assembly 1100 and allow the liquid to drain out of the coalescing region and back into the enclosure 1200. In some embodiments, where the liquid is oil, the coalescing region 1180 is not a sorbent of oil. In multiple embodiments, the coalescing region 1180 is oleophobic in nature, which can prevent wicking of oil against gravity upwards, towards the passive airflow vent 1114, by reducing capillary action of the coalescing region 1180. In some embodiments, the coalescing region is oleophilic, however.

The coalescing region 1180 can be a variety of types of materials and combinations of materials. In various embodiments, the coalescing region 1180 is a porous plug that is consistent with porous plugs described elsewhere herein. In some other examples, the coalescing region 1180 can have coalescing filter media. bi-component fibers. In some embodiments, the coalescing region 1180 can have glass fibers. In at least one embodiment the glass fibers are microfibers. Generally, the coalescing region 1180 substantially lacks a binder material, where the term “binder material” is defined herein to exclude the fibers in the coalescing region, such as the bi-component fibers or other fibers. In a variety of embodiments, the coalescing region 1180 of the vent assembly 1100 contains coalescing filter media. Coalescing filter media in the coalescing region 1180 of the vent assembly 1100 can be a stack of a plurality of layers of synthetic filter media. A substantial portion of the layers can be stacked such that each flow face of each layer of filter media is in direct contact with the flow faces of adjacent layers of filter media. The term “flow face” is used to mean each surface of the filter media that is configured to face the directions of airflow through the airflow pathway 1112. In some other embodiments, the coalescing region 1180 has coalescing filter media that is a mass of fibers disposed in the coalescing region 1180. In some embodiments, the coalescing region 1180 has coalescing filter media that is a rolled sheet of filter media.

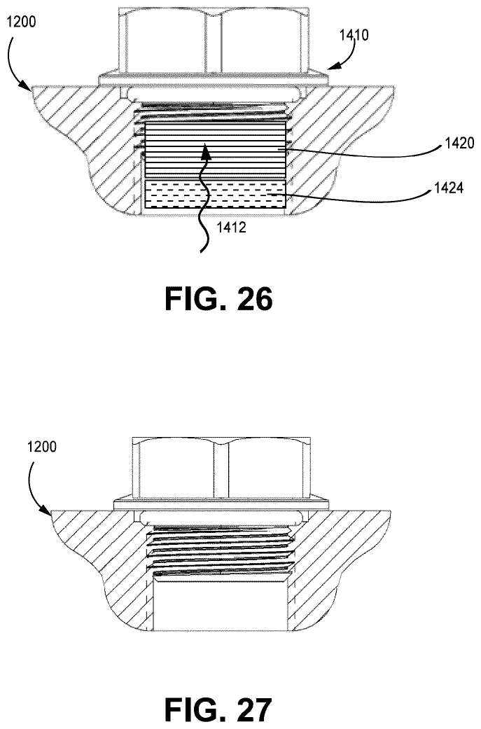

In a variety of embodiments where the vent assembly has coalescing filter media disposed within the vent housing, a porous plug can be used as a barrier between the enclosure and the coalescing filter media. FIG. 26 shows an example embodiment demonstrating the vent assembly having coalescing filter media 1420 disposed within the vent housing 1410 consistent with the technology disclosed herein. The coalescing filter media 1420 is generally configured to allow fluid communication between the airflow pathway 1412 and the environment external to the vent housing 1410 through the coalescing filter media 1420.

In some embodiments consistent with this example, the porous plug 1424 is positioned towards the first end of the vent housing relative to the coalescing filter media. The porous plug 1424 can have relatively high permeability to facilitate gravity-assisted liquid coalescing and drainage through the first end of the vent assembly.

In a variety of embodiments, the vent assembly defines a spacing region 1172 between the coalescing region and the passive airflow vent. Returning again to FIG. 24, the spacing region 1172 of the vent assembly 1100 is generally configured to prevent contact between liquid from the enclosure and the passive airflow vent 1114. In particular, the spacing region 1172 can be configured to impede wicking of the liquid towards the passive airflow vent. The spacing region 1172 can also be configured to prevent contact between the coalescing region 1180 and the passive airflow vent 1114. The spacing region 1172 can be a physical barrier between the coalescing region and the passive airflow vent. In at least one embodiment, the spacing region 1172 can be a physical barrier that is configured to contain the material in the coalescing region within the coalescing region.

In some embodiment, the spacing region 1172 is a media spacer disposed within the vent housing 1110 between the coalescing region and the passive airflow vent. In such an example, the media spacer can be configured to engage one or more of the vent housing, the passive airflow vent, a porous plug, and the coalescing region. In an alternate embodiment, the spacing region lacks a media spacer and is merely a physical gap between the coalescing region and the passive airflow vent.

In some embodiments, there is a spacing region between the porous plug and the coalescing filter media. The spacing region can otherwise be consistent with the discussion of the spacing region 1172 above.

In some embodiments of the current technology, the vent assembly has a vent housing that is constructed of porous plastic. In such an example, the vent housing can omit a porous plug, although in some embodiments a porous plug can be used in combination with a porous vent housing. The vent housing can be constructed of materials consistent with the description of the materials used to construct the porous plug, described in detail above. The vent housing can also have parameters, such as porosity and void volumes consistent with the description of porous plugs above.

In some embodiments, the housing has a cap towards the second end. In such embodiments, the cap extends across the airflow pathway. The vent cap is coupled to the vent housing and is generally configured to shield a flow face of the second end of the vent housing from the environment. In a variety of embodiments, the cap is constructed of porous plastic. In such examples, the cap can be constructed consistently with the materials and parameters described above with respect to the porous plug.

In some embodiments, the housing has a cap towards the second end. FIGS. 23-27 shows an example embodiments demonstrating the housing has a cap towards the second end consistent with the technology disclosed herein. In such embodiments, the cap extends across the airflow pathway. The vent cap is coupled to the vent housing and is generally configured to shield a flow face of the second end of the vent housing from the environment. In some such embodiments, the vent cap is configured to shield a flow face of a passive airflow vent. In a variety of embodiments, the cap is constructed of porous material such as a porous plastic. In some other embodiments, the cap can be constructed of a non-porous material such as a non-porous thermoplastic. In some embodiments where the cap is porous, the vent housing can omit openings to the external environment because the airflow pathway can be defined through the pores of the cap. In some embodiments where the cap is non-porous and non-breathable, the housing and/or the cap can define perimeter openings that connect the airflow pathway with the external environment.

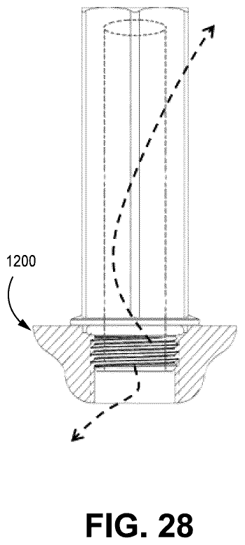

FIGS. 27 and 28 show example embodiments demonstrating an alternate vent assembly consistent with the technology disclosed herein. The vent assembly generally has a vent housing. The vent housing has a first end and a second end. The vent housing generally has a mounting structure, a vent body, and a second airflow pathway. The mounting structure is generally configured to couple to an enclosure. The mounting structure is additionally configured to encompass any structure that can couple the vent assembly to an enclosure. The mounting structure also defines an opening that has a first airflow pathway which is configured for fluid communication with the interior of the enclosure. In the current examples, the vent housing can be porous. For example, the vent housing can be constructed of a porous material consistent with the descriptions above relevant to the porous plug.

The mounting structure can be consistent with mounting structures described above. In some embodiments, the mounting structure is similarly porous to the vent body. In some such embodiments, the mounting structure is an integral, unitary component with the vent body. In some other embodiments, the mounting structure is non-porous and is constructed of a different material or combination of materials than the vent body.

In some embodiments, the vent body and the mounting structure form a structural fastener. FIG. 27 shows an example embodiment demonstrating the mounting structure form a structural fastener consistent with the technology disclosed herein. A structural fastener is defined as a component that is configured to mechanically join features together through frictional engagement with at least one other component. The structural fastener can be any suitable structure, such as for example, a bolt, screw, hose connector, or the like. In some embodiments, the vent body defines a screw thread that is configured to couple a cover to a housing.

In some embodiments, also as shown in FIG. 27, the vent body and the mounting structure define a reservoir cover. The reservoir cover is generally configured to isolate the contents of a reservoir from the external environment. In some embodiments, the reservoir cover can be an oil cap. In some other embodiments, the reservoir cover can be a cap other than an oil cap. In examples where the structural fastener defines a hose connector, the structural fastener can be configured to couple two hose segments. In such an example, the structural fastener can have two ends each configured to frictionally engage a hose segment to bring the hose segments into fluid communication through the hose connector.

In some embodiments, the vent body defines an elongate cavity. As such, as used herein, the term “elongate cavity” refers to a cavity having a length longer than it's wide. An elongate cavity may advantageously increase the surface area of the vent body relative to a vent body that are not elongate, which may advantageously provide a relative increase in airflow.

In some embodiments where the vent body and/or the mounting structure is porous, the vent assembly does not define openings separate from the pores. In some embodiments, the vent assembly does not define openings separate from the pores towards the second end of the vent body. In some embodiments, the vent assembly does not define openings separate from the pores towards the first end of the vent body. In some other embodiments, the vent assembly defines an opening through the mounting structure that is configured for direct fluid communication with the interior of an enclosure. In some such embodiments, the second end of the vent assembly does not define an opening separate from the pores such that the external environment is in fluid communication with the airflow pathway through the pores.

It is noted that in some embodiments where the vent body is porous, the valve assembly can incorporate a passive airflow vent and/or a coalescing region. Further, a vent cover can be coupled to the second end of the valve assembly, where the vent cover can be porous/breathable or non-porous/non-breathable.

In a variety of embodiments, the vent assembly can additionally have a porous plug disposed in the vent housing. the porous plug is generally configured to allow the fluid communication between the first airflow pathway and the second airflow pathway through the porous plug. In some embodiments, the porous plug has a larger pore size than the vent housing. In some embodiments, the porous plug is configured to capture an aerosol such as oil aerosol. In some such embodiments, the vent housing can have a smaller maximum pore size than the porous plug to prevent water from entering the vent assembly from the outside environment. In embodiments incorporating a porous plug in a porous housing, the porous plug can be coupled to the vent housing through approaches discussed above with respect to coupling porous plugs to vent housings. Similarly, the porous plug can have configurations consistent with other porous plugs described herein.

### Exemplary Aspects of Vent Assembly

Aspect 1. A vent assembly comprising:
a vent housing having a first end and a second end, wherein the vent
housing defines a mounting structure and an airflow pathway extending from the mounting structure to the environment external to the vent housing; and
a porous plug coupled to the vent housing and disposed across the airflow pathway, wherein the porous plug is positioned between the first end and the second end.

Aspect 2. The vent assembly of any one of Aspects 1 and 3-39, wherein the vent assembly is not a hub cap vent.

Aspect 3. The vent assembly of any one of Aspects 1-2 and 4-39, wherein the porous plug has a mean pore size of 0.1 μm to 100 μm, 0.1 μm to 10 μm, or 1 μm to 50 μm.

Aspect 4. The vent assembly of any one of Aspects 1-3 and 5-39, wherein the porous plug has a maximum pore size of less than 350 μm, 200 μm, 100 μm, or 50 μm.

Aspect 5. The vent assembly of any one of Aspects 1-4 and 6-39, wherein the porous plug has a void volume between 30% to 50%.

Aspect 6. The vent assembly of any one of Aspects 1-5 and 7-39, wherein the porous plug has a pore size range that changes from a first axial end of the porous plug to a second axial end of the porous plug.

Aspect 7. The vent assembly of any one of Aspects 1-6 and 8-39, wherein the porous plug comprises at least one polymer in the group consisting of: polytetrafluoroethylene, polysulfone, polyethylene, polyethylenimine, polypropylene and polyvinylidene difluoride.

Aspect 8. The vent assembly of any one of Aspects 1-7 and 9-39, wherein the porous plug comprises ceramic.

Aspect 9. The vent assembly of any one of Aspects 1-8 and 10-39, wherein the porous plug comprises sintered metal.

Aspect 10. The vent assembly of any one of Aspects 1-9 and 11-39, wherein the porous plug comprises an adsorbent.

Aspect 11. The vent assembly of any one of Aspects 1-10 and 12-39, wherein the porous plug comprises adsorbent particles.

Aspect 12. The vent assembly of any one of Aspects 1-11 and 13-39, wherein the adsorbent particles comprise carbon particles.

Aspect 13. The vent assembly of any one of Aspects 1-12 and 14-39, wherein the porous plug has a thickness in the range of 0.02-4.0 inches or 0.03-2.0 inches.

Aspect 14. The vent assembly of any one of Aspects 1-13 and 15-39, wherein the porous plug defines a check valve positioned towards the first end of the vent housing to selectively obstruct the airflow pathway.

Aspect 15. The vent assembly of any one of Aspects 1-14 and 16-39, wherein the porous plug has an oleophobic coating.

Aspect 16. The vent assembly of any one of Aspects 1-15 and 17-39, wherein the porous plug and the vent housing define mating threads.

Aspect 17. The vent assembly of any one of Aspects 1-16 and 18-39, wherein the porous plug defines a taper in an axial direction.

Aspect 18. The vent assembly of any one of Aspects 1-17 and 19-39, wherein the airflow pathway defines a taper in the axial direction.

Aspect 19. The vent assembly of any one of Aspects 1-18 and 20-39, wherein the porous plug and the vent housing define a frictional fit.

Aspect 20. The vent assembly of any one of Aspects 1-19 and 21-39, wherein the porous plug and the vent housing are welded.

Aspect 21. The vent assembly of any one of Aspects 1-20 and 22-39, further comprising coalescing filter media disposed within the vent housing such that the airflow pathway and the environment external to the vent housing are in communication through the coalescing filter media.

Aspect 22. The vent assembly of any one of Aspects 1-21 and 23-39, wherein the porous plug is a first porous plug, and wherein the vent assembly comprises a second porous plug disposed across the airflow pathway, the second porous plug having a different porosity than the first porous plug, and the first porous plug and the second porous plug arranged in series along the airflow pathway.

Aspect 23. The vent assembly of any one of Aspects 1-22 and 24-39, wherein the porous plug defines a plurality of laterally extending layers arranged in an axial direction and at least one cavity between the layers.

Aspect 24. The vent assembly of any one of Aspects 1-23 and 25-39, wherein the porous plug defines a plurality of cavities.

Aspect 25. The vent assembly of any one of Aspects 1-24 and 26-39, wherein the porous plug defines a draining pathway through the first end.

Aspect 26. The vent assembly of any one of Aspects 1-25 and 27-39, wherein at least one of the laterally extending layers define an incline in the axial direction.

Aspect 27. The vent assembly of any one of Aspects 1-26 and 28-39, further comprising a passive airflow vent disposed in the vent housing across the airflow pathway.

Aspect 28. The vent assembly of any one of Aspects 1-27 and 29-39, wherein the passive airflow vent is the porous plug.

Aspect 29. The vent assembly of any one of Aspects 1-28 and 30-39, wherein the passive airflow vent is a breathable membrane.

Aspect 30. The vent assembly of any one of Aspects 1-29 and 31-39, wherein the vent assembly defines a coalescing region within the airflow pathway between the mounting structure and the passive airflow vent.

Aspect 31. The vent assembly of any one of Aspects 1-30 and 32-39, wherein the coalescing region comprises coalescing filter media.

Aspect 32. The vent assembly of any one of Aspects 1-31 and 33-39, wherein the coalescing region comprises the porous plug.

Aspect 33. The vent assembly of any one of Aspects 1-32 and 34-39, wherein the porous plug is positioned towards the first end relative to the coalescing filter media.

Aspect 34. The vent assembly of any one of Aspects 1-33 and 35-39, wherein the vent assembly defines a spacing region between the coalescing region and the passive airflow vent.

Aspect 35. The vent assembly of any one of Aspects 1-34 and 36-39,

further comprising a media spacer between the coalescing filter media and the porous plug, wherein the media spacer is configured to prevent contact between the coalescing region and the porous plug and is configured to define a portion of the airflow pathway.

Aspect 36. The vent assembly of any one of Aspects 1-35 and 37-39, wherein the housing defines perimeter openings such that the airflow pathway extends from the porous plug to the external environment through the perimeter openings.

Aspect 37. The vent assembly of any one of Aspects 1-36 and 38-39, wherein the vent housing is constructed of porous plastic.

Aspect 38. The vent assembly of any one of Aspects 1-37 and 39, wherein the housing comprises a cap towards the second end, wherein the cap extends across the airflow pathway.

Aspect 39. The vent assembly of any one of Aspects 1-38, wherein the cap is porous.

Aspect 40. A vent assembly comprising:
a vent housing having a first end and a second end, wherein the vent housing defines a mounting structure and an airflow pathway extending from the mounting structure to the environment external to the vent housing; and
a porous plug coupled to the vent housing and disposed across the airflow pathway, wherein the porous plug defines a plurality of laterally extending layers arranged in an axial direction and at least one cavity between the layers.

Aspect 41. The vent assembly of any one of Aspects 40 and 42-78,

wherein the porous plug has a mean pore size of 0.1 μm to 100 μm, 0.1 μm to 10 μm, or 1 μm to 50 μm.

Aspect 42. The vent assembly of any one of Aspects 40-41 and 43-78, wherein the porous plug has a maximum pore size of less than 350 μm, 200 μm, 100 μm, or 50 μm.

Aspect 43. The vent assembly of any one of Aspects 40-42 and 44-78, wherein the porous plug has a void volume between 30% to 50%.

Aspect 44. The vent assembly of any one of Aspects 40-43 and 45-78, wherein the porous plug has a pore size range that changes from a first axial end of the porous plug to a second axial end of the porous plug.

Aspect 45. The vent assembly of any one of Aspects 40-44 and 46-78, wherein the porous plug comprises at least one polymer in the group consisting of: polytetrafluoroethylene, polysulfone, polyethylene, polyethylenimine, polypropylene and polyvinylidene difluoride.

Aspect 46. The vent assembly of any one of Aspects 40-45 and 47-78, wherein the porous plug comprises ceramic.

Aspect 47. The vent assembly of any one of Aspects 40-46 and 48-78, wherein the porous plug comprises sintered metal.

Aspect 48. The vent assembly of any one of Aspects 40-47 and 49-78, wherein the porous plug comprises an adsorbent.

Aspect 49. The vent assembly of any one of Aspects 40-48 and 50-78, wherein the porous plug defines a cavity and adsorbent is disposed in the cavity.

Aspect 50. The vent assembly of any one of Aspects 40-49 and 51-78, wherein the porous plug comprises adsorbent particles.

Aspect 51. The vent assembly of any one of Aspects 40-50 and 52-78, wherein the adsorbent particles comprise carbon particles.

Aspect 52. The vent assembly of any one of Aspects 40-51 and 53-78, wherein the porous plug has a thickness in the range of 0.02-4.0 inches or 0.03-2.0 inches.

Aspect 53. The vent assembly of any one of Aspects 40-52 and 54-78, wherein the porous plug defines a check valve positioned towards the first end of the vent housing to selectively obstruct the airflow pathway.

Aspect 54. The vent assembly of any one of Aspects 40-53 and 55-78, wherein the porous plug has an oleophobic coating.

Aspect 55. The vent assembly of any one of Aspects 40-54 and 56-78, wherein the porous plug and the vent housing define mating threads.

Aspect 56. The vent assembly of any one of Aspects 40-55 and 57-78, wherein the porous plug defines a taper in an axial direction.

Aspect 57. The vent assembly of any one of Aspects 40-56 and 58-78, wherein the airflow pathway defines a taper in the axial direction.

Aspect 58. The vent assembly of any one of Aspects 40-57 and 59-78, wherein the porous plug and the vent housing define a frictional fit.

Aspect 59. The vent assembly of any one of Aspects 40-58 and 60-78, wherein the porous plug and the vent housing are welded.

Aspect 60. The vent assembly of any one of Aspects 40-59 and 61-78, further comprising coalescing filter media disposed within the vent housing such that the airflow pathway and the environment external to the vent housing are in communication through the coalescing filter media.

Aspect 61. The vent assembly of any one of Aspects 40-60 and 62-78, wherein the porous plug is a first porous plug, and wherein the vent assembly comprises a second porous plug disposed across the airflow pathway, the second porous plug having a different porosity than the first porous plug, and the first porous plug and the second porous plug arranged in series along the airflow pathway.

Aspect 62. The vent assembly of any one of Aspects 40-61 and 63-78, wherein the porous plug defines a plurality of cavities.

Aspect 63. The vent assembly of any one of Aspects 40-62 and 64-78, wherein the porous plug defines a draining pathway through the first end.

Aspect 64. The vent assembly of any one of Aspects 40-63 and 65-78, wherein at least one of the laterally extending layers define an incline in the axial direction.

Aspect 65. The vent assembly of any one of Aspects 40-64 and 66-78, further comprising a passive airflow vent disposed in the vent housing across the airflow pathway.

Aspect 66. The vent assembly of any one of Aspects 40-65 and 67-78, wherein the passive airflow vent is a breathable membrane.

Aspect 67. The vent assembly of any one of Aspects 40-66 and 68-78, wherein the passive airflow vent is a porous plug.

Aspect 68. The vent assembly of any one of Aspects 40-67 and 69-78, wherein the vent assembly defines a coalescing region within the airflow pathway between the mounting structure and the passive airflow vent.

Aspect 69. The vent assembly of any one of Aspects 40-68 and 70-78, wherein the coalescing region comprises coalescing filter media.

Aspect 70. The vent assembly of any one of Aspects 40-69 and 71-78 wherein the coalescing region comprises the porous plug.

Aspect 71. The vent assembly of any one of Aspects 40-70 and 72-78, wherein the porous plug is positioned towards the first end relative to the coalescing filter media.

Aspect 72. The vent assembly of any one of Aspects 40-71 and 73-78, wherein the vent assembly defines a spacing region between the coalescing region and the passive airflow vent.

Aspect 73. The vent assembly of any one of Aspects 40-72 and 74-78, further comprising a media spacer between the coalescing filter media and the porous plug, wherein the media spacer is configured to prevent contact between the coalescing region and the porous plug and is configured to define a portion of the airflow pathway.

Aspect 74. The vent assembly of any one of Aspects 40-73 and 75-78, wherein the housing defines perimeter openings such that the airflow pathway extends from the porous plug to the external environment through the perimeter openings.

Aspect 75. The vent assembly of any one of Aspects 40-74 and 76-78, wherein the vent housing is constructed of porous plastic.

Aspect 76. The vent assembly of any one of Aspects 40-75 and 77-78, wherein the housing comprises a cap towards the second end, wherein the cap extends across the airflow pathway.

Aspect 77. The vent assembly of any one of Aspects 40-76 and 78, wherein the cap is constructed of porous plastic.

Aspect 78. The vent assembly of any one of Aspects 40-77, wherein the porous plug defines a cavity and adsorbent is disposed in the cavity.

Aspect 79. A vent assembly comprising:
a vent housing having a first end and a second end, wherein the vent housing comprising:
a mounting structure, wherein the mounting structure is configured to couple to an enclosure, wherein the mounting structure defines a first airflow pathway configured for fluid communication with an interior of the enclosure;
a vent body defining the second end, wherein the vent body is coupled to the mounting structure and the vent body is constructed of a porous plastic defining pores; and
a second airflow pathway configured for fluid communication with the environment external to the vent housing, wherein the second airflow pathway extends through the pores.

Aspect 80. The vent assembly of any one of Aspects 79 and 81-115, wherein the vent body and the mounting structure are an integral, unitary component.

Aspect 81. The vent assembly of any one of Aspects 79-80 and 82-115, wherein the mounting structure is constructed of porous plastic.

Aspect 82. The vent assembly of any one of Aspects 79-81 and 83-115, wherein the vent body and the mounting structure form a structural fastener.

Aspect 83. The vent assembly of any one of Aspects 79-82 and 84-115, wherein the vent body and the mounting structure define a reservoir cover.

Aspect 84. The vent assembly of any one of Aspects 79-83 and 85-115, wherein the vent body and the mounting structure define a hose.

Aspect 85. The vent assembly of any one of Aspects 79-84 and 86-115, wherein the vent body extends axially outward from the mounting structure.

Aspect 86. The vent assembly of any one of Aspects 79-85 and 87-115, wherein the vent body defines an elongate cavity.

Aspect 87. The vent assembly of any one of Aspects 79-86 and 88-115, wherein the vent assembly does not define openings in addition to the pores towards the second end.

Aspect 88. The vent assembly of any one of Aspects 79-87 and 89-115, wherein the vent body comprises a cap towards the second end.

Aspect 89. The vent assembly of any one of Aspects 79-88 and 90-115, wherein the vent body has a mean pore size of 0.1 μm to 100 μm, 0.1 μm to 10 μm, or 1 μm to 50 μm.

Aspect 90. The vent assembly of any one of Aspects 79-89 and 91-115, wherein the vent body has a maximum pore size of less than 350 μm, 200 μm, 100 μm, or 50 μm.

Aspect 91. The vent assembly of any one of Aspects 79-90 and 92-115, wherein the vent body has a void volume between 30% to 50%.

Aspect 92. The vent assembly of any one of Aspects 79-91 and 93-115, wherein the vent body has a pore size range that changes from a first axial end of the vent body to a second axial end of the vent body.

Aspect 93. The vent assembly of any one of Aspects 79-92 and 94-115, wherein the vent body comprises at least one polymer in the group consisting of: polytetrafluoroethylene, polysulfone, polyethylene, polyethylenimine, polypropylene and polyvinylidene difluoride.

Aspect 94. The vent assembly of any one of Aspects 79-93 and 95-115, wherein the vent body comprises ceramic.

Aspect 95. The vent assembly of any one of Aspects 79-94 and 96-115, wherein the vent body comprises sintered metal.

Aspect 96. The vent assembly of any one of Aspects 79-95 and 97-115, wherein the vent body comprises an adsorbent.

Aspect 97. The vent assembly of any one of Aspects 79-96 and 98-115, wherein the vent body comprises adsorbent particles.

Aspect 98. The vent assembly of any one of Aspects 79-97 and 99-115, wherein the adsorbent particles comprise carbon particles.

Aspect 99. The vent assembly of any one of Aspects 79-98 and 100-115, further comprising coalescing filter media disposed within the vent housing such that the first airflow pathway and the second airflow pathway are in communication through the coalescing filter media.

Aspect 100. The vent assembly of any one of Aspects 79-99 and 101-115, further comprising a porous plug disposed in the vent housing such that the first airflow pathway and the second airflow pathway are in communication through the porous plug.

Aspect 101. The vent assembly of any one of Aspects 79-100 and 102-115, wherein the porous plug and the vent housing define mating threads.

Aspect 102. The vent assembly of any one of Aspects 79-101 and 103-115, wherein the porous plug defines a taper in an axial direction.

Aspect 103. The vent assembly of any one of Aspects 79-102 and 104-115, wherein the airflow pathway defines a taper in the axial direction.

Aspect 104. The vent assembly of any one of Aspects 79-103 and 105-115, wherein the porous plug and the vent housing define a frictional fit.

Aspect 105. The vent assembly of any one of Aspects 79-104 and 106-115, wherein the porous plug is a first porous plug, and wherein the vent assembly comprises a second porous plug disposed in the housing, the second porous plug having a different porosity than the first porous plug, and the first porous plug and the second porous plug arranged in series between the first airflow pathway and the second airflow pathway.

Aspect 106. The vent assembly of any one of Aspects 79-105 and 107-115, wherein the porous plug has an oleophobic coating.

Aspect 107. The vent assembly of any one of Aspects 79-106 and 108-115, wherein the porous plug defines a plurality of laterally extending layers arranged in an axial direction and at least one cavity between the layers.

Aspect 108. The vent assembly of any one of Aspects 79-107 and 109-115 wherein the porous plug defines a plurality of cavities.

Aspect 109. The vent assembly of any one of Aspects 79-108 and 110-115, wherein the porous plug defines a draining pathway through the first end.

Aspect 110. The vent assembly of any one of Aspects 79-109 and 111-115, wherein the porous plug and the vent housing are welded.

Aspect 111. The vent assembly of any one of Aspects 79-110 and 112-115, wherein the porous plug has a mean pore size of 0.1 μm to 100 μm, 0.1 μm to 10 μm, or 1 μm to 50 μm.

Aspect 112. The vent assembly of any one of Aspects 79-111 and 113-115, wherein the porous plug has a maximum pore size of less than 350 μm, 200 μm, 100 μm, or 50 μm.

Aspect 113. The vent assembly of any one of Aspects 79-112 and 114-115, wherein the porous plug has a void volume between 30% to 50%.

Aspect 114. The vent assembly of any one of Aspects 79-113 and 115, wherein the porous plug has a pore size range that changes from a first axial end of the porous plug to a second axial end of the porous plug.

Aspect 115. The vent assembly of any one of Aspects 79-114, wherein the porous plug defines a cavity and adsorbent is disposed in the cavity.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A pressure relief assembly comprising:
a valve body comprising breathable porous plastic having: an outer perimetric surface defining a detent mating surface, and a sealing surface configured to form a seal around a valve opening; and
a first detent having a detent engagement surface configured to releasably engage the detent mating surface, wherein the first detent is configured to release the valve body upon a minimum pressure differential across the valve body and the first detent is configured to extent laterally outward from the detent mating surface.

2. The pressure relief assembly of claim 1, further comprising a frame comprising a coupling structure configured to couple to an enclosure, a valve mounting surface, and the valve opening within the valve mounting surface, wherein the valve body is sealably disposed on the valve mounting surface across the valve opening.

3. The pressure relief assembly of claim 2, wherein the first detent is coupled to the frame.

4. The pressure relief assembly of claim 2, wherein the frame further comprises breathable porous plastic.

5. The pressure relief assembly of claim 1, wherein the valve body has an oleophobic coating.

6. The pressure relief assembly of claim 1, wherein the valve body has a mean pore size of 0.1 μm to 100 μm, 0.1 μm to 10 μm, or 1 μm to 50 μm.

7. The pressure relief assembly of claim 1, wherein the valve body has a maximum pore size of less than 350 μm, 200 μm, 100 μm, or 50 μm.

8. The pressure relief assembly of claim 1, wherein the valve body has a void volume between 30% to 50%.

9. The pressure relief assembly of claim 1, wherein the valve body comprises at least one polymer in the group consisting of: polytetrafluoroethylene, polysulfone, polyethylene, polyethylenimine, polypropylene and polyvinylidene difluoride.

10. The pressure relief assembly of claim 1, wherein the valve body comprises ceramic.

11. The pressure relief assembly of claim 1, wherein the valve body comprises an adsorbent.

12. The pressure relief assembly of claim 11, wherein the valve body defines a cavity and the adsorbent is disposed in the cavity.

13. The pressure relief assembly of claim 1, wherein the valve body comprises adsorbent particles.

14. The pressure relief assembly of claim 13, wherein the adsorbent particles comprise carbon particles.

15. The pressure relief assembly of claim 1, wherein the valve body is configured to obstruct passage of liquid water.

16. The pressure relief assembly of claim 1, where the valve body further comprises a hinge that is configured to pivotably couple the valve body to an enclosure.

17. The pressure relief assembly of claim 1, the valve body comprising a plug portion and a valve stem extending in an axial direction from the plug portion, wherein the first detent extends laterally to the valve stem.

18. The pressure relief assembly of claim 1, wherein the first detent is a spring-loaded detent.

19. The pressure relief assembly of claim 1, wherein the first detent comprises a detent housing having a first end and an open second end, a compression spring disposed in the detent housing, the compression spring extending from the first end towards the open second end, wherein the detent engagement surface is translatably disposed in the detent housing, and wherein the compression spring is compressibly disposed between the detent engagement surface and the first end of the detent housing.

20. The pressure relief assembly of claim 1, wherein the first detent is a magnet.
